(19) United States
(12) Patent Application Publication
(10) Pub. No.: US 2013/0291708 A1
(43) Pub. Date: Nov. 7, 2013

(54) VIRTUAL AUDIO EFFECTS PACKAGE AND CORRESPONDING NETWORK

(71) Applicant: Jesse Harris Orshan, Roslyn Heights, NY (US)

(72) Inventor: Jesse Harris Orshan, Roslyn Heights, NY (US)

(21) Appl. No.: 13/875,069

(22) Filed: May 1, 2013

Related U.S. Application Data
(60) Provisional application No. 61/641,042, filed on May 1, 2012.
(60) Provisional application No. 61/816,100, filed on Apr. 25, 2013.

(51) Int. Cl. G10H 1/02

(52) U.S. Cl. CPC G10H 1/02
USPC 84/626

(57) ABSTRACT

A system, method and computer-readable medium incorporating instructions are provided to enable a user to create and to share a digital effects package. The instructions enable user input of a first sound effect, and a first trigger that, when activated, plays the first sound effect, and to associate the first sound effect and the first trigger with the digital effects package. The trigger can be on a musical instrument, such as on a fretboard or fingerboard of a stringed instrument. The digital effects package may be created and shared by a user at a first terminal connected via a network.

### CROSS REFERENCE TO RELATED APPLICATIONS

The present application claims priority to U.S. Provisional Patent Application No. 61/641,042, filed May 1, 2012 and to U.S. Provisional Patent Application No. 61/816,100, filed Apr. 25, 2013, the entire contents of both of which are incorporated herein by reference.

### BACKGROUND

1. Field of the Disclosure

The present disclosure relates, generally, to audio technology and, more particularly, to creating and sharing a portfolio of audio sound effects and musical instrument sound modification and enhancement packages, and to triggers for activating the same.

2. Related Art

Musical effects are used by many musicians, including guitarists. The majority of those musicians, particularly those who play for live audiences, employ “effects pedals” for the musical effects and to obtain different sounds when playing.

There is a very large market for effects pedals. Generally, there are two options that musicians have when deciding to make a purchase. First, a musician may purchase individual effect pedals (which may cost between $100-200 dollars). Each of these individual effect pedals creates a specific sound (such as distortion, delay, flanger, chorus, or the like). Although sometimes desirable for having a preferred quality, individual effect pedals are expensive and are cumbersome because of the requirement of having a plurality of the pedals to achieve a variety of audio effects. A musician who wants to have a plurality of effects, typically, needs to purchase a number of individual effect pedals for each respective effect.

Another option for musicians is to purchase a multi-effects pedal. This is an effects pedal that is configured to provide anywhere from a dozen to up to hundreds of audio effects. A multi-effects pedal may range in price between $200-$800. One shortcoming of multi-effects pedals is that a musician, typically, will never use an effect that the musician does not like. This may result in dozens or hundreds of purchased effects that go unused.

Some known computer programs, such as LOGIC, include features that allow musicians to customize audio effects. (See, for example, FIGS. 1-4). However, such known applications only allow musicians to record with these effects. The musician has no way to take an effect that (s)he has created out into the world to be played without bringing a laptop computer, computer equipment, and other expensive programs with him/her.

Software programs available from music distribution retailers such as Guitarcenter and Sam Ash allow creation of sound effects. Ableton is software that allows musicians to build sounds, and digital triggers to sit on their “launchpads.” However, this software does not allow musicians to package custom effects into a virtual package. This program is intended for use by a musician but the sounds cannot be easily shared. iStomp is software that is sold by Digitech that sells e-pedals that are created by Digitech. Musicians cannot create their own custom e-pedals and cannot customize e-pedals. Also, Digitech e-pedals do not allow music sound clip triggering and users must select from pedals that are provided by Digitech. Further, iRig, sold by IK Multimedia, provides e-pedals as well. However, this company sells hardware connectors and the e-pedals cannot be built, constructed or customized but must be selected from the pedals provided by the company.

The inventor recognizes that certain kinds of music, particularly the type of music that employs effects pedals, is supposed to be about complete freedom and creativity. Unfortunately, musicians are only able to play the sounds that effects companies are willing to sell to them, or must purchase multiple individual effect pedals.

In addition, musicians often wish to create a portfolio of sound effects for later playback, such as during a performance and to create portfolios of such sound effects that can be shared and saved for later use in a convenient manner. In addition, musicians wish to share such combinations of sound effects and to sell them or exchange them with other musicians.

### SUMMARY

The present application provides a way to allow musicians to have greater autonomy over the way their musical instruments sound. In an embodiment, the present application provides an online network in which musicians can share/sell their sound effects. Moreover, in an embodiment, the present application provides a computer program, effects pedals, and a social network. When a user opens the program, the user is able to manipulate and upload sound effects in virtually an infinite number of ways and is able to build custom audio effects for use on an effects pedal and that may be distributed over the network.

A system, method and computer-readable medium incorporating instructions is provided to enable a user to create and to share a digital effects package. The computer-readable medium incorporating instructions configured to enable a user to create and to share a digital effects package, may include first sound effect interface instructions to enable user input, to a computer, of a first sound effect, and to enable user input of a first trigger that, when activated, plays the first sound effect, and to associate the first sound effect and the first trigger with the digital effects package; second sound effect interface instructions to enable user input, to the computer, of a second sound effect, and to enable user input of a second trigger that, when activated, plays a second sound effect, and to associate the second sound effect and the second trigger with the digital effects package; and digital effects package displaying and storing instructions that, when transmitted automatically by the computer, cause the digital effects package to be displayed and to be stored for later activation of the first and second triggers, and enable sharing of the digital effects package by a first user at a first terminal and a second user at a second terminal, the first and second terminal connected via a network.

The instructions may further include: a musical instrument sound modification interface to receive, by the computer, a user command to alter a sound produced by a musical instrument and to associate the input instruction with the digital effects package; and a musical instrument sound modification instructions configured to modify the sound of the instrument in accordance with the command when the digital effects package is activated.

The first trigger may be a spot on a guitar fretboard connected to the computer, or may be a spot on a stringed musical instrument fingerboard, a key or a note on a musical instrument, a button on a musical instrument.

The instructions may further include: visual effects interface instructions that enable user input, to the computer, of a video clip, a visual effect, special effects, or pyrotechnics effects; and third trigger selection instructions that enable user input of a third trigger that, when activated, commences performance of the video clip, the visual effect, the special effects, or the pyrotechnics effects, and to associate the video clip, the visual effect, the special effects, or the pyrotechnics effects and the third trigger with the digital effects package.

In addition, the instructions may include: recording trigger interface instructions to enable user input, to the computer, of a recording trigger that, when activated, commences recording of a performance as a recorded sound effect, and to associate the recording trigger with the digital effects package.

The instructions may further include: first kill switch interface instructions that enable user input, to the computer, of a first kill switch trigger that, when activated, stops playback of the first sound effect, and to associate the first kill switch trigger with the digital effects package.

Also, the instructions may include: looping trigger interface instructions to enable user input, to the computer, of a looping trigger that, when activated, commences looping of a selected sound effect, and to associate the looping trigger with the digital effects package.

For example, the kill switch trigger, the looping trigger, the recording trigger may be one or more spots on a stringed musical instrument fingerboard, such as a on guitar fretboard.

Also described is a system that includes a remote module comprising: remote module instructions executed by a second computer, the second computer being remote from the computer in communication over a network with the computer, and the remote module instructions to provide a graphical user interface to enable user input of the first sound effect and the first trigger.

The remote module may include: musical instrument interface instructions to enable user input of the first sound effect from a musical instrument.

The remote module further can include: trigger receiving instructions that enable user input of the first trigger from a musical instrument, and that associate the first trigger with the first sound effect.

In addition, a method is provided to enable a user to create and to play a digital effects package, the method comprising: receiving, by a machine, from a user, user selection of a first sound effect and user selection of a first trigger, that, when activated, plays the first sound effect; associating the first sound effect and the first trigger with the digital effects package; and playing the sound effect when the user activates the first trigger, the first trigger being a position on a fingerboard of the stringed musical instrument.

The method can also include: receiving, by the machine, user selection of a second sound effect and user selection of a second trigger, that, when activated, plays the second sound effect; associating the second sound effect and the second trigger with the digital effects package; and playing the sound effect when the user activates the second trigger.

Also disclosed is an audio modification system comprising processor executable instructions including: instructions to define a trigger signal based on a user input; instructions to enable a processor to detect a first trigger signal received from a signal input; instructions to activate a first sound effect function associated with the first trigger; and instructions to modify a signal received from the signal input according to the first sound effect function.

Such an audio modification system may further include instructions to enable the processor to detect a second trigger signal received from the signal input and to deactivate the first sound effect function upon detection of the second trigger signal. Further, such a system may also include instructions to enable the processor to detect a third trigger signal received from the signal input, to activate a second sound effect function upon detection of the second trigger signal, and to further modify the modified signal with the second sound effect function.

Users can layer such sound effects and clips on top of each other, can create a series of sound effects, and can create a trigger that when activated plays back the sound effect.

In accordance with the present application, a musician is provided with a way to plug an effects pedal into a computer, upload effects (s)he designed onto the pedal, and then go use that pedal during a live performance.

Other features and advantages of the present invention will become apparent from the following description of the invention that refers to the accompanying drawings.

### BRIEF DESCRIPTION OF THE FIGURES

FIG. 1 illustrates an example of a graphical user interface to allow a user to create or to vary a sound clip or a musical instrument sound, according to an aspect of the present disclosure.

FIG. 2 illustrates an example of a graphical user interface showing a flanger function, according to an aspect of the present disclosure.

FIG. 3 illustrates an example of a graphical user interface that a user can use to implement various functions to create or to change the sound clip or the musical instrument sound, according to an aspect of the present disclosure.

FIG. 4 illustrates an example of a graphical user interface screen that enables the user to create or to modify a sound clip or to vary a musical sound, according to an aspect of the present disclosure.

FIG. 5 illustrates an example of a graphical user interface showing a guitar fretboard to enable the user to create a sound clip, according to an aspect of the present disclosure.

FIG. 6 illustrates an example of a graphical user interface providing a drop bar to allow the user to create or to change the sound clip, according to an aspect of the present disclosure.

FIG. 7 illustrates an example of a graphical user interface to enable the user to select a portion of a sound graph to create or to change the sound clip, according to an aspect of the present disclosure.

FIG. 8 illustrates an example of a graphical user interface showing the drop bar in which the portion of the sound graph has been positioned to create the sound clip, according to an aspect of the present disclosure.

FIG. 9 illustrates an example of a graphical user interface showing a trigger being created and associated with the sound clip, according to an aspect of the present disclosure.

FIG. 10 illustrates an example of a graphical user interface enabling the naming of the trigger shown in FIG. 9, according to an aspect of Applicant's disclosure.

FIG. 11 illustrates an example of a graphical user interface showing that the sound clip trigger illustrated in FIG. 10 has been named according to an aspect of Applicant's disclosure.

FIG. 12 illustrates an example of a graphical user interface showing the sound clip trigger shown in FIG. 11 being associated with the sound clip, according to an aspect of Applicant's disclosure.

FIG. 13 illustrates an example of a graphical user interface showing the position on the fretboard of the trigger shown in FIG. 12, according to an aspect of Applicant's disclosure.

FIG. 14 illustrates an example of a graphical user interface showing the user creating a musical effect or sound for a musical instrument, according to an aspect of Applicant's disclosure.

FIG. 15 illustrates an example of a graphical user interface showing various space designer options for creating the sound or modality for the musical instrument shown in FIG. 14, according to an aspect of Applicant's disclosure.

FIG. 16 illustrates an example of a physical electronic pedal with an electronic display, according to an aspect of Applicant's disclosure.

FIG. 17 illustrates an example of the physical pedal showing the fretboard, according to an aspect of Applicant's disclosure.

FIGS. 18-25 illustrate a range of views of the physical electronic pedal, according to an aspect of Applicant's disclosure.

FIG. 26 illustrates an example of a graphical user interface enabling the user to select a design resembling a pedal or other shape for a visual representation of the digital effects package, according to an aspect of Applicant's disclosure.

FIGS. 27-31 illustrates examples of a graphical user interface showing further user customization of the look and functionality provided by the visual representation of the digital effects package, according to an aspect of Applicant's disclosure.

FIG. 32 illustrates an example of a graphical user interface enabling the user to choose various options for creating and modifying the sound effect or for modifying musical instrument sound or mode, according to an example of Applicant's disclosure.

FIG. 33 illustrates an example of sound effect sharing system architecture, according to an example of Applicant's disclosure.

FIG. 34 illustrates an example of a digital effect package, according to an aspect of Applicant's disclosure.

FIG. 35 illustrates an example of an effects delivery system, according to an aspect of Applicant's disclosure.

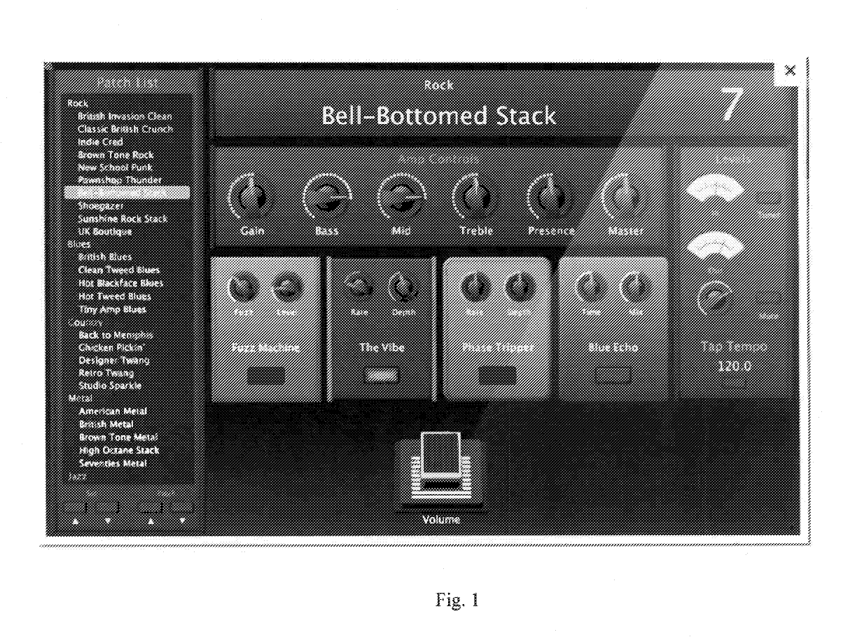

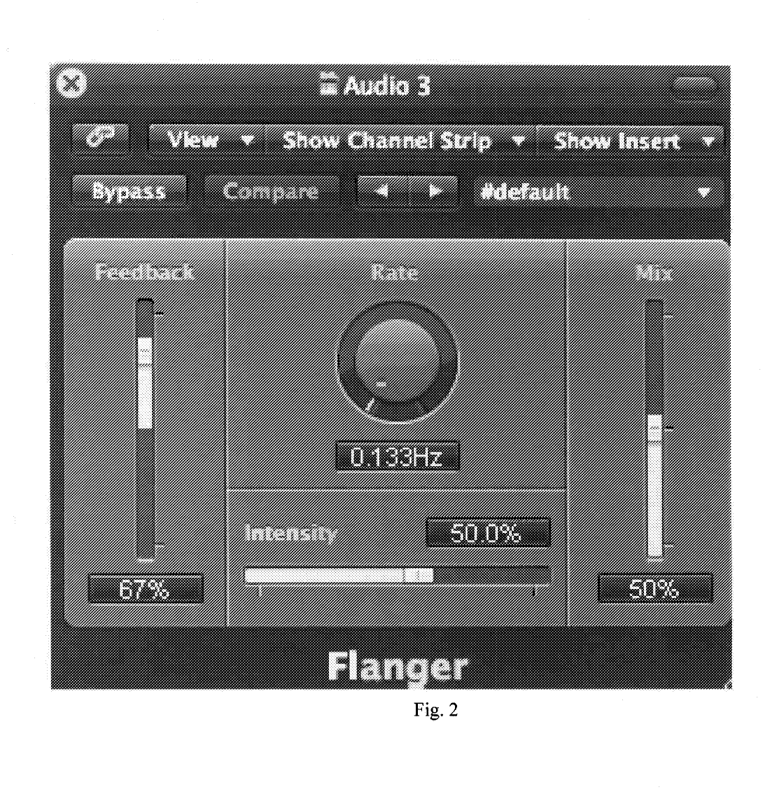

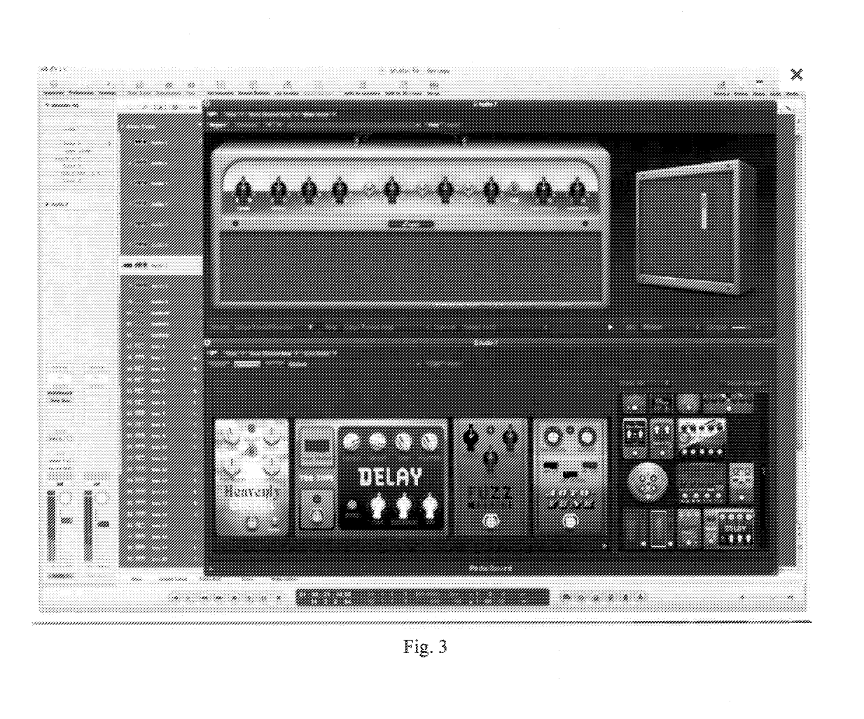

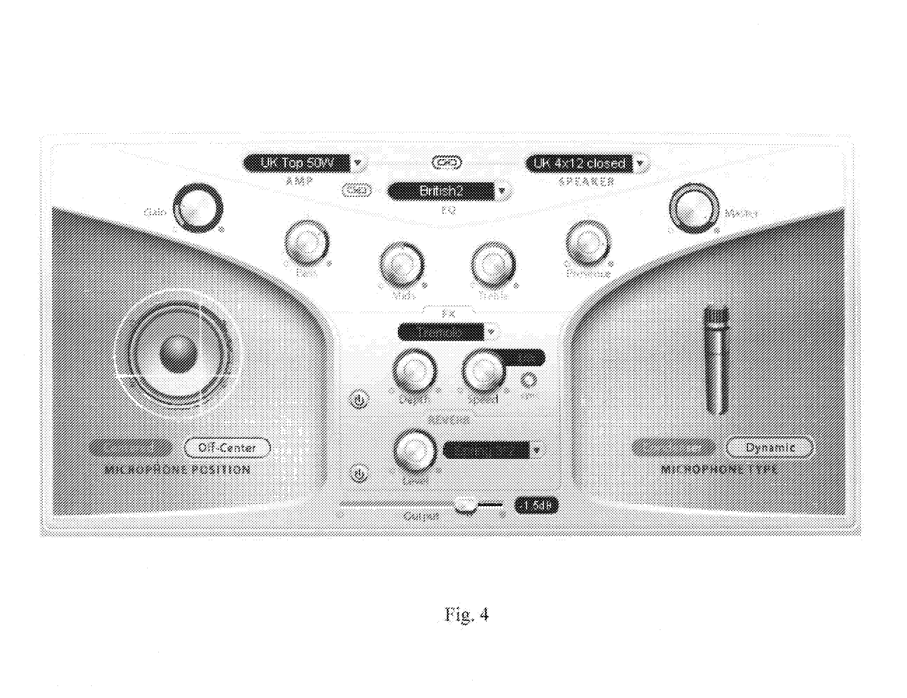

### DETAILED DESCRIPTION OF THE EMBODIMENTS

The present application allows musicians to have autonomy over the way they sound, and further provides an online network in which musicians can share/sell their sound effects.

As noted above, the present application provides an online platform or network (similar to ITUNES) in which musicians can share and/or sell the sound effects that they have created to the network of musicians. For example, an online center is provided in which musicians can “shop” for sounds that they like, by listening to a sample, and being able to download the effect onto their pedal boards. This creates a “social network” in which musicians are able to not only share, but also play each other's sound effects. This network creates a new universe in which musicians are not bound to the sounds that sound effects companies sell on the market. Instead, a musician can choose to put the effects that (s)he creates up for free, or for a price (s)he deems to be appropriate. This gives musicians the opportunity to take the sounds that they hear in their head, and to turn the sounds into something tangible. In an embodiment, the content is provided by the people who use the program.

An example of an operation of the sound effect sharing system, method, and computer-readable medium will now be described with reference to the drawings.

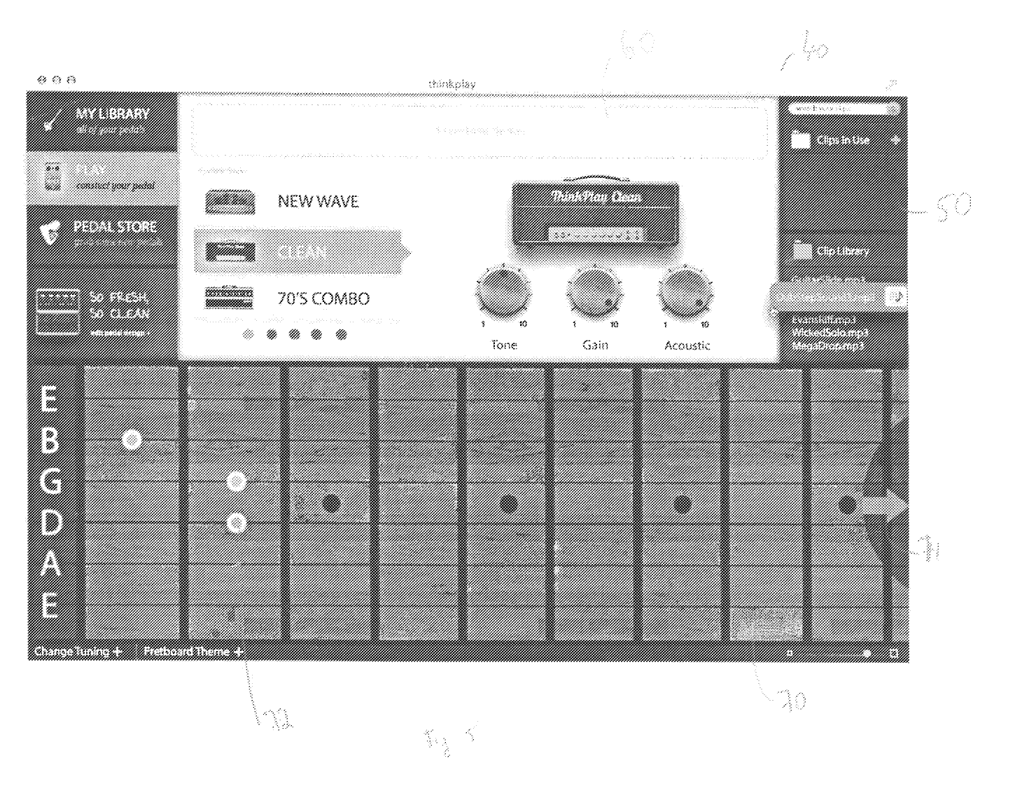

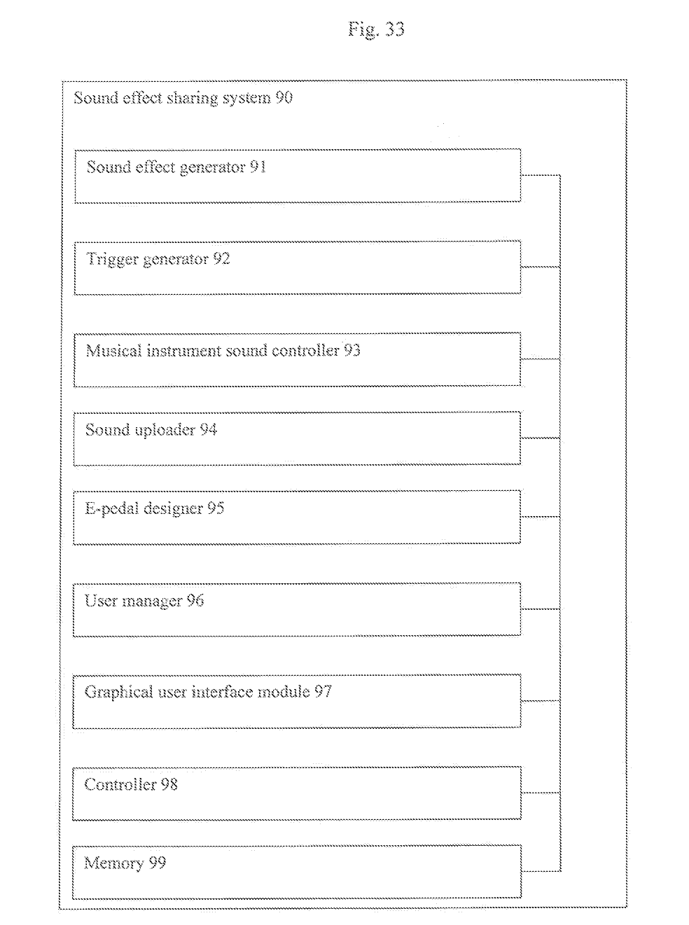

As illustrated in FIG. 5 a user wishes to create a sound effect that he will call DubStepSound3.mp3 using the sound effect sharing system 90 shown in FIG. 33. Sound effect generator 91 of sound effect sharing system 90 provides instructions to graphical user interface module shown in FIG. 33 to enable the user to create, change and store sound effects and associate them with a digital effects package. It will be understood, however, that the user may specify just about any name for the sound effect, and that the sound effect need not be in the MP3 format. For example, the MIDI (Musical Instrument Digital Interface) format and protocol may be used to create, share and communicate sound effects, sound clips, instrument sound modifications, and the like, in addition to other protocols and formats, and that more than one such standard or protocol may be used to create portions of the same sound effect or of the digital effects package. The musician can use a pickup device, such as a hexaphonic pickup, to create the sound effect or sound clip. The user can similarly create, share and communicate video clips, footage, images, visual effects and the like, in a variety of formats, including mpeg, jpeg or the like, and can also create and share combinations of sound and video/visual effects to be triggered by a single trigger or by more than one trigger.

FIG. 5 illustrates a fretboard shown to the user. The user may use this fretboard to create sound effects and sound modification of the musical instrument sound, or the user may connect electronically his or her own musical instrument such as a guitar or keyboard or the like to the computer, smartphone, handheld device, tablet, PC or the like, or to a wireless router directly for communicating with the sound effects sharing system 90 over a network, such as over the internet. Fretboard 70 is navigable using navigation arrow 71 shown on the right hand portion of FIG. 5.

In the example illustrated, fretboard 70 shows that the user is playing a chord by playing the B, G and D strings, either using the system interface or using a musical instrument connected via a network to the system, as described above, to play the notes. While shown as fretboard of a guitar, it will be understood that the system can also be programmed using a variety of virtual instrument interfaces, such as other types of stringed instruments, such as a banjo, ukulele, violin or bass, and including a piano, or electronic organ keyboards, or other percussion instruments or electronic instruments, wind instruments or the like, as well as using a variety of real world musical instruments, including those discussed for the virtual world, connected to the system via network. In addition, various types of electronic devices, including handheld devices, smartphones, personal computers and other portable devices provide musical instrument functionality that can be used to accomplish this function.

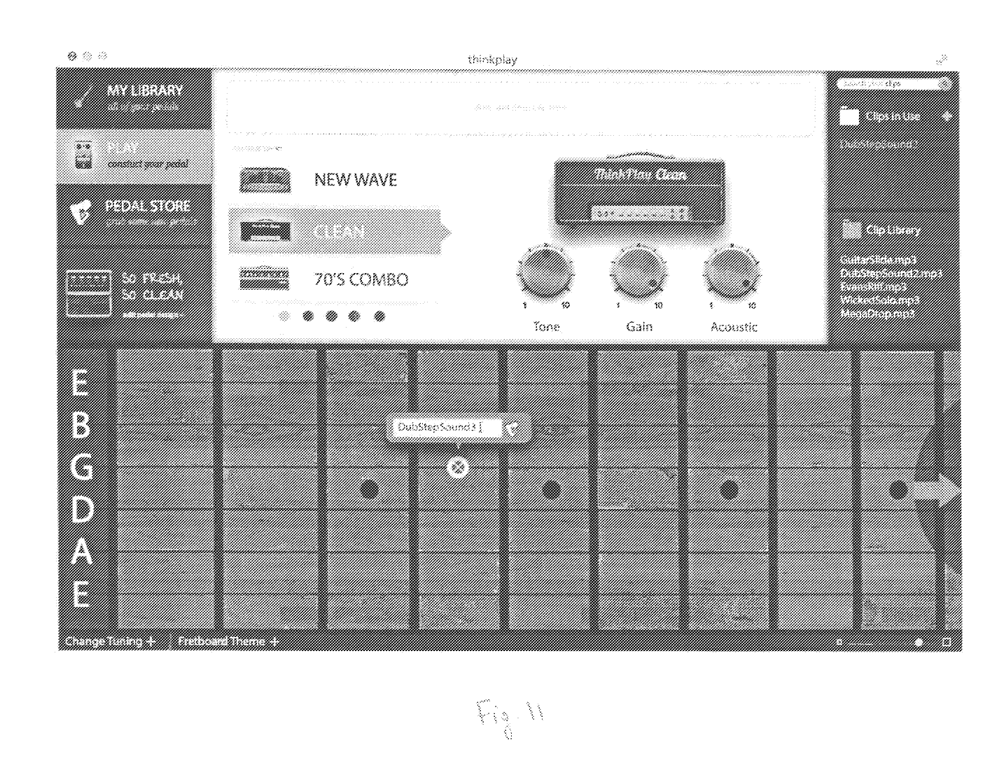

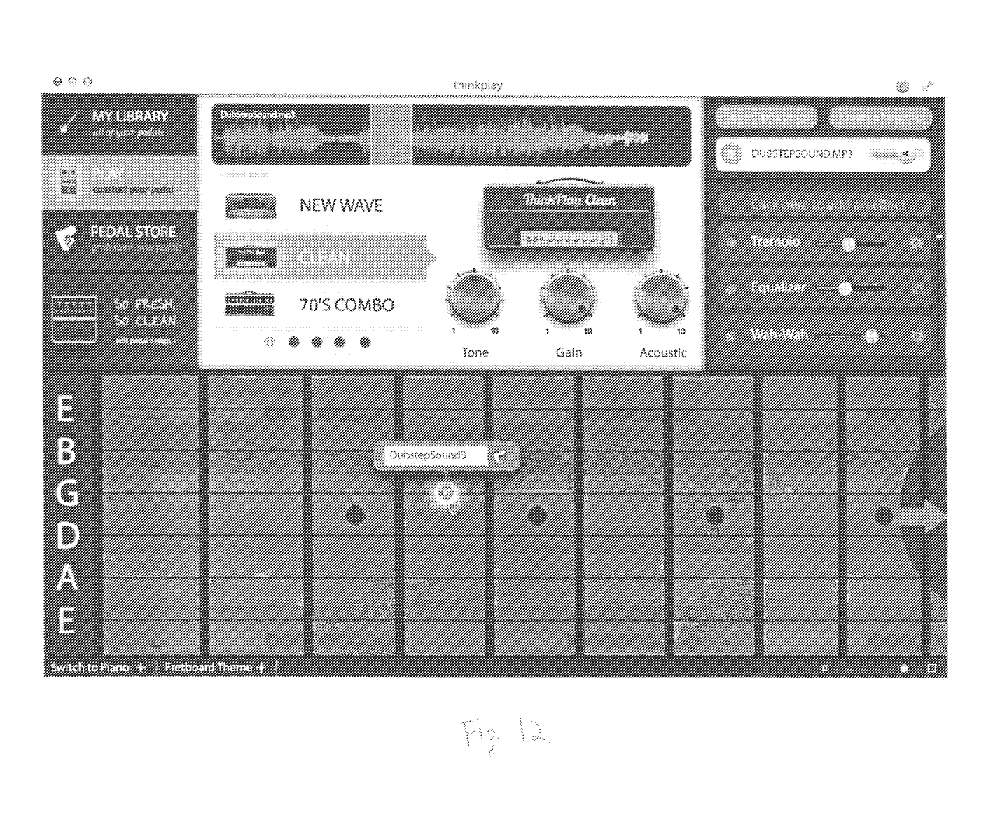

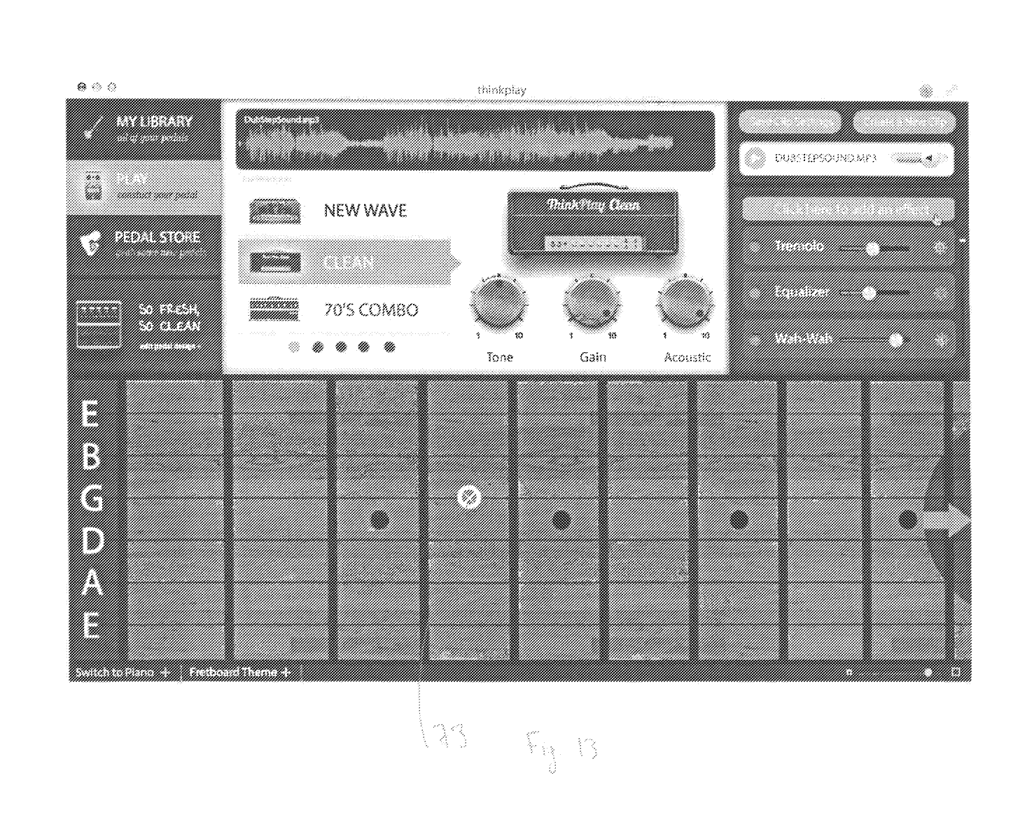

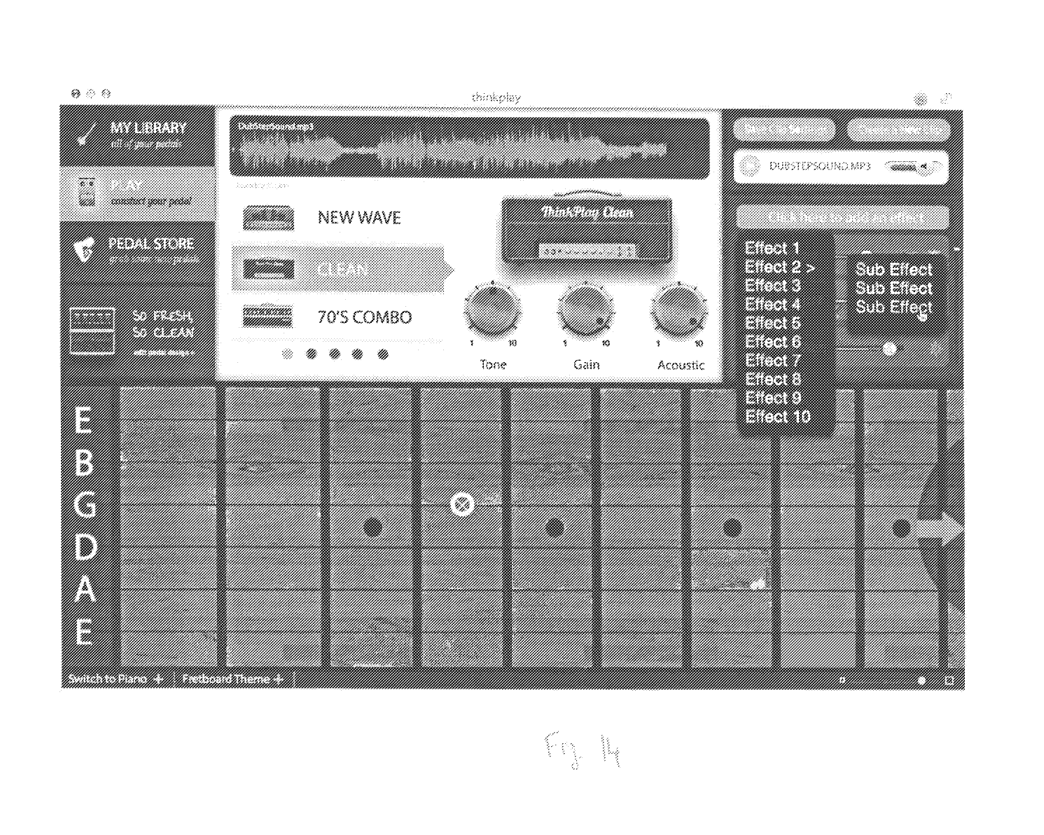

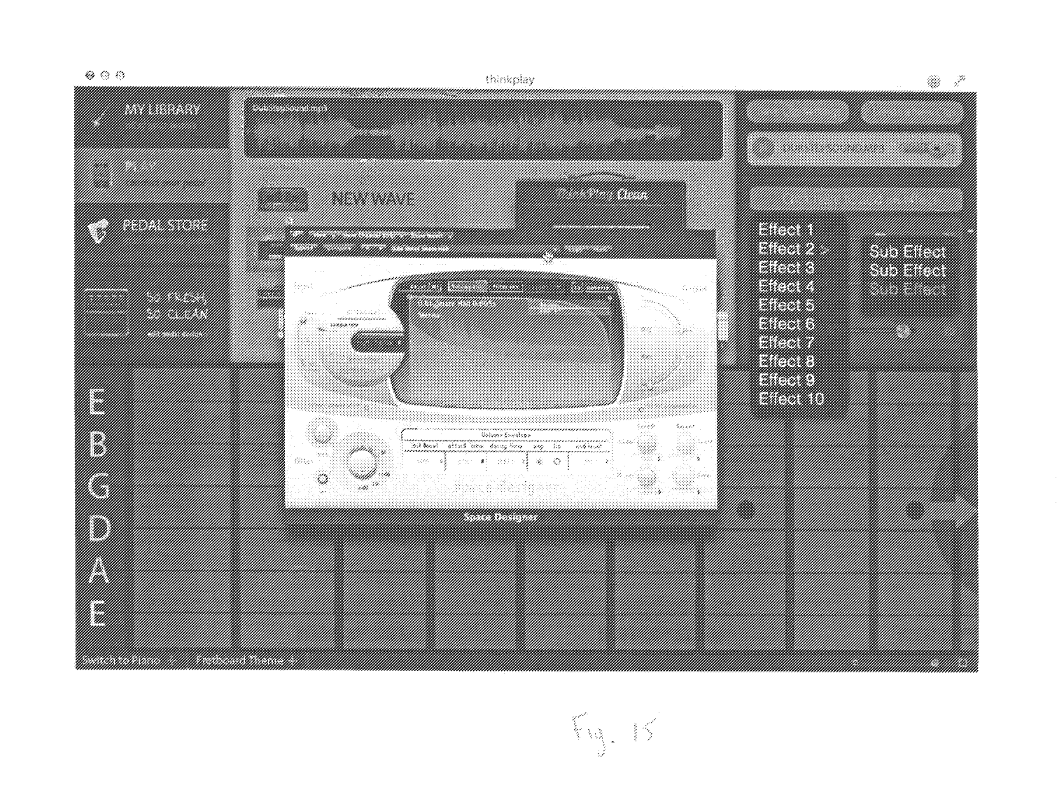

Using the graphical user interface illustrated in FIGS. 5-15, the user can accomplish the following types of tasks:

(1) the user can modify the sound of a musical instrument to create a musical instrument sound modality, for example, using the tone, gain, an acoustic knob as illustrated in panel 60, and associate such sound modification with a digital effects package for later playback. In this way, once stored, when later the musical instrument is played, and this digital effects package is selected, then the sound produced by the musical instrument will be modified accordingly and/or

(2) the user can create sound effects or sound recordings or upload sound recordings, can adjust or modify such sound effects, and associate the produced sound effect with the digital effects package. In this way, when later then digital effects package is activated user can trigger the sound effect produced that has been associated with and stored with the digital effects package.

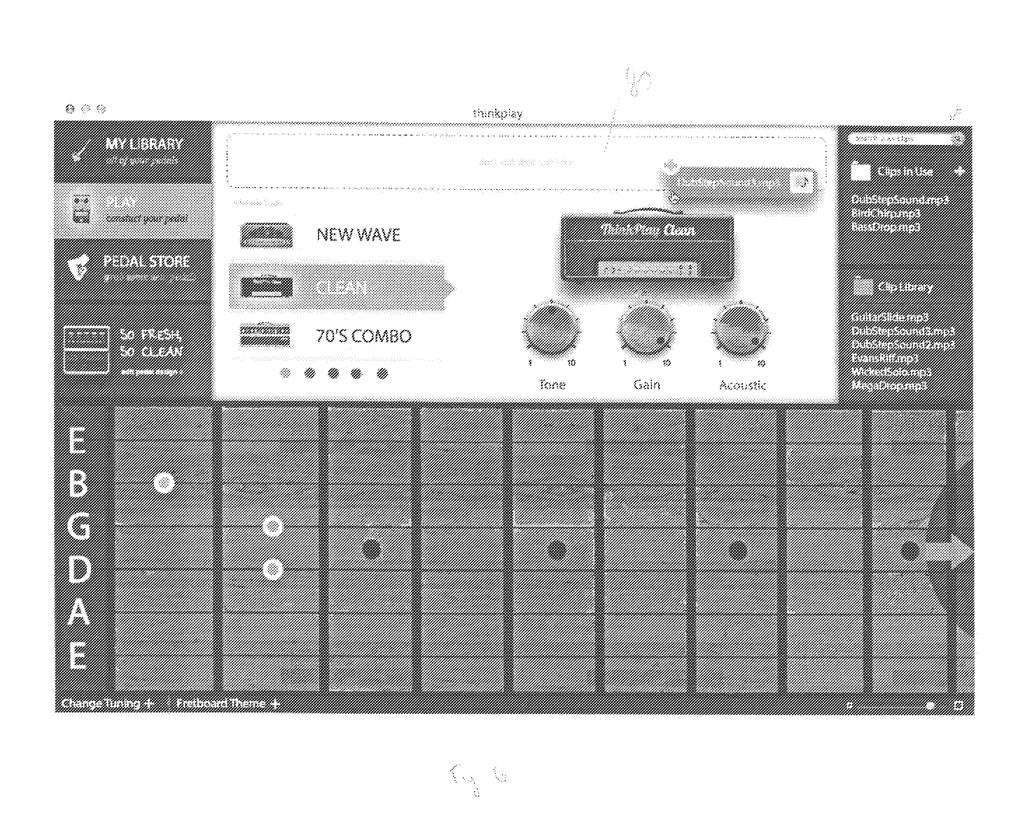

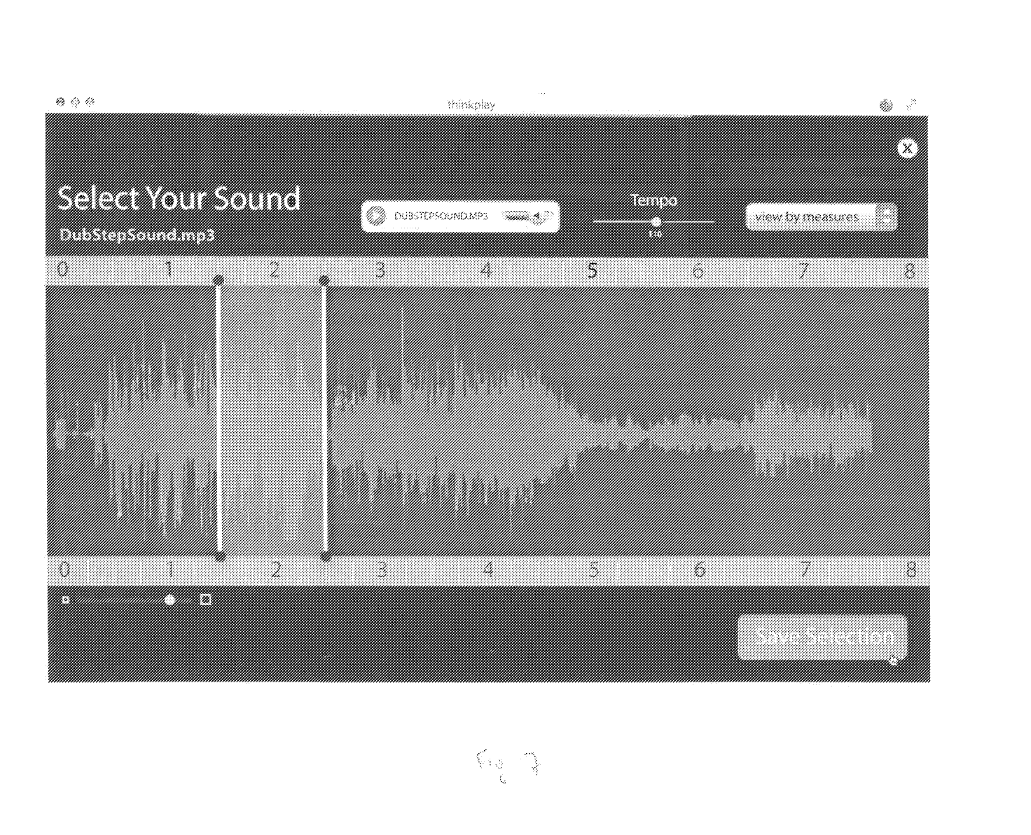

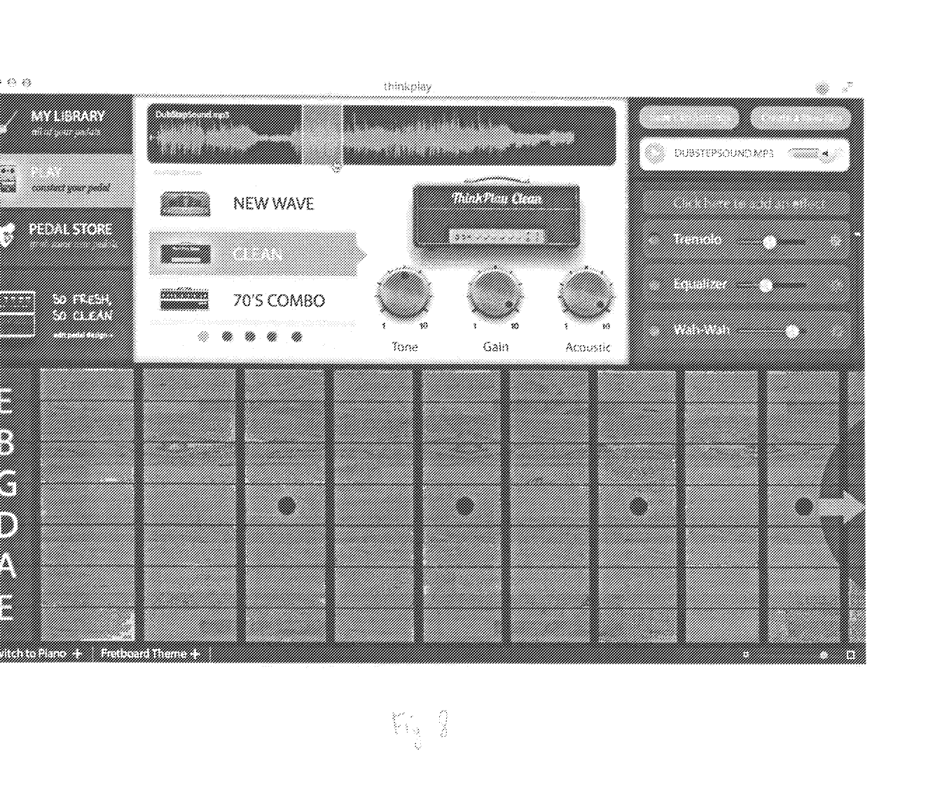

Sound effect panel 50 in FIG. 6 illustrates several names of sound effects that have been created and stored by the user, in addition to the sound effect DubStepSound3.mp3. FIG. 6 also shows that the DubStepSound3.mp3 sound effect is dragged and dropped to creation panel 80. As discussed, sound effect DubStepSound3.mp3 consists of the chord produced by the B, G and D strings played on the fretboard of the guitar as shown in FIG. 5. Each sound clip or a package of sound clips stored on a digital effects package may also be encrypted, at the user's discretion, so that other users with whom the user shares the sound effect, video clip or footage, or the entire digital effects package will be prevented from deconstructing, altering and/or sharing the digital package or from replicating it without specific permission from the user who stored it. In this way, effects formulas can be kept secret by the user even if the user wishes to share the digital effects package. FIG. 7 illustrates that the user takes a portion of sound waves produced as part of sound effect DubStepSound.mp3 by selecting a portion thereof. This drag and drop feature makes creating a sound clip and a digital effects package easy and convenient. FIG. 8 then illustrates creation panel 80 that shows this snippet of the sound waves.

However, the term sound effect as used herein, can include a variety of types of sounds and sound clips, including clips of songs or other music, human voices, stock sounds, or samples, such as laughter, a door opening, a glass breaking, pieces played on a musical instrument, such as a left hand piece played on a piano, a drum roll or the like, as well as combinations of the foregoing. Also, the sound effect may include clips that the user places one on top of the other so as to produce a layered effect for the sound effect. Moreover, the number of sound clips can be stored by the system for convenience of the user, and the user can upload sound effects of his own or sound effects that he has obtained elsewhere. The user can also advantageously program a musical accompaniment to a piece to be triggered by trigger 73 and designated as the sound effect. In this way, the user can accompany himself why playing the guitar, by pressing the trigger 73 and getting a piano or drum or bass accompaniment or the like. User can create a number of such sound effects and triggers and associate them with the same digital effects package. In this way, all the sound effects needed to be triggered in a single performance or single song or the like can be stored on the same e-pedal. A number of such digital effects packages can be created by the user, and such digital effects packages can then be shared with other users.

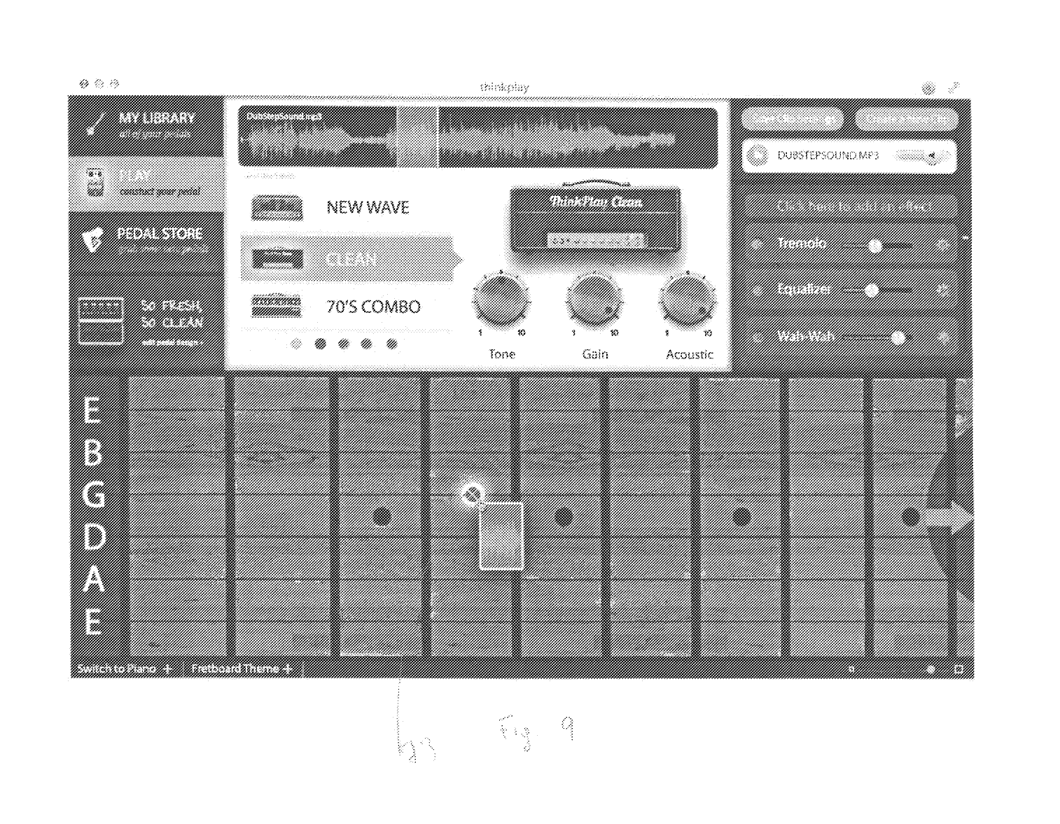

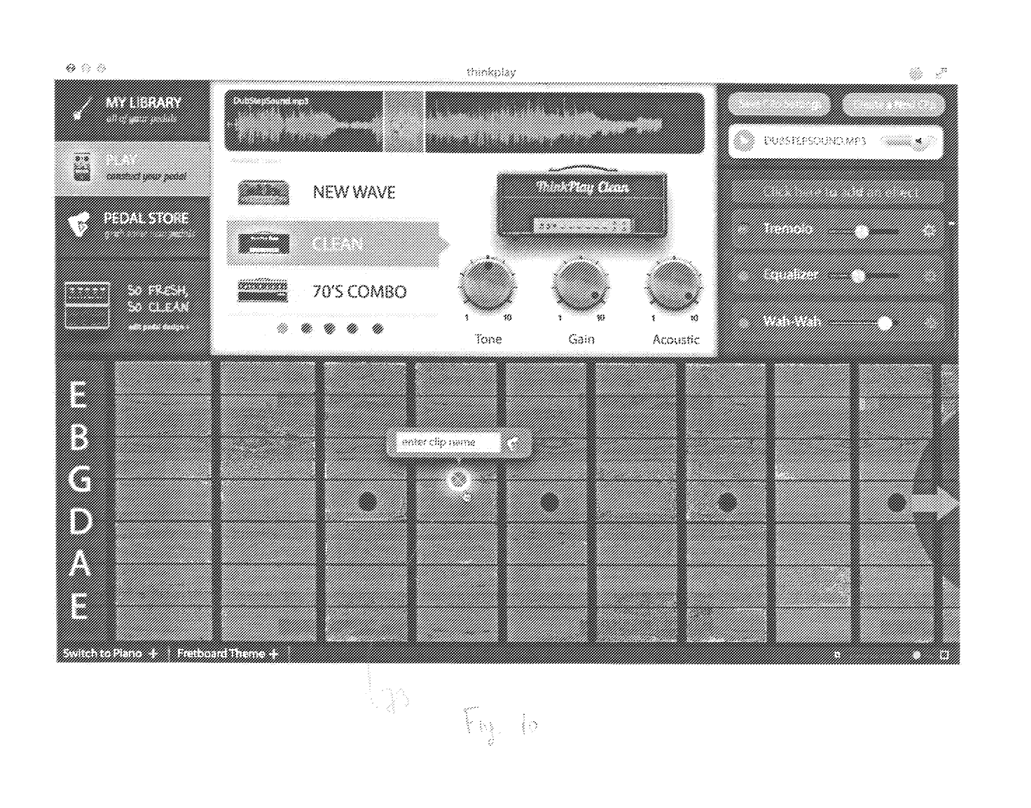

FIG. 9 illustrates the user creating a trigger that when pressed or activated will cause the sound effect DubStepSound3 to be played. Trigger generator 92 of sound effect sharing system 90 illustrated in FIG. 33 provides instructions to graphical user interface module 97 to enable the user to create and change triggers, to associate them with a particular button, such as a note, key or location of a musical instrument, and to associate them with respective sound effects of the digital effects package. In particular, user designates a button on his fretboard that, when pressed, will trigger this sound effect. This sound effect is associated with a digital effects package. FIG. 10 illustrates that the user enters a name for this clip or sound effect, which he or she calls DubStepSound3.mp3. In this way, later when the digital effects package is activated by the user and the user presses trigger 73, such as during a performance, this sound effect will automatically be played. In this way, user need not simultaneously play the guitar and operate a computer or other type of device to activate the sound effect he needs or desires for his performance.

For example, controller 90 of sound effect sharing system 90 illustrated in FIG. 33 will receive a signal indicating that a trigger has been activated, will identify the sound effect, musical instrument sound modification, and/or visual effects associated with the trigger, will determine the action to be taken in response to the trigger, for example, to activate, to deactivate, to loop, to record, or the like the relevant sound effect, musical instrument sound modification, and/or visual effects associated with the trigger, and will then cause the associated processor to take the required action.

By way of illustration, if the musician activates a trigger located on his or stringed instrument fingerboard, fretboard or keyboard during a performance, and the trigger has been previously programmed to start a sound effect of a digital effects package, then controller 98, residing on a computer, electric pedal, handheld device, smartphone or other portable device connected wirelessly or via a wired connection to the musical instrument, will receive a signal indicating that the trigger has been activated, will identify the sound effect, musical instrument sound modification, and/or visual effects associated with the trigger by consulting memory 99 of sound effect sharing system 90 illustrated in FIG. 33 or a local memory in which the digital effect package has been stored, will determine what type of action (e.g. start playback, stop playback, start looping, stop looping, start recording, stop recording, close/open curtain, turn on/off lighting, start/stop video, start/stop visual effect, start/stop pyrotechnics, start/stop sound distortion, echo, etc.) this trigger was programmed to trigger, and will take action, for example, by playing the associated sound effect on a speaker connected to the computer, electric pedal, handheld device, smartphone or other portable device.

However, it will be understood that a module with controller 98 may be implemented as part of the musical instrument, or as part of a computer, electric pedal, handheld device, smartphone or other portable device, remote from the musical instrument and connected via a network, such as a LAN, WAN or the Internet.

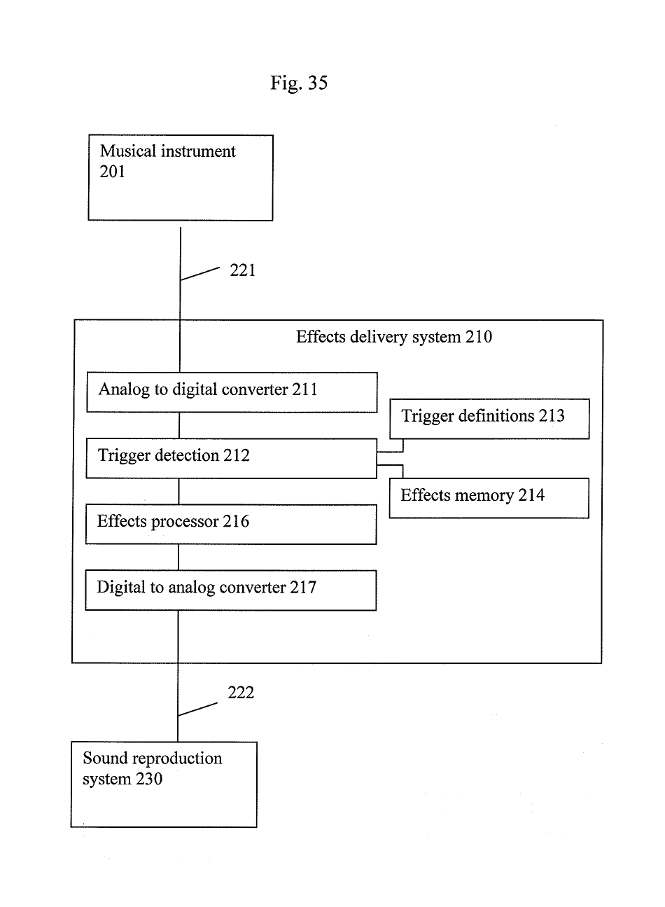

An example of an effects delivery system is illustrated in FIG. 35. The user has downloaded a digital effects package to the effects delivery system 210 and the user has established a connection between a effects delivery system 210 and musical instrument 201. For example, musical instrument 201 may be an electric guitar or electric keyboard that is plugged in or wirelessly connected to a physical electric pedal, smartphone, handheld device, personal computer, tablet or other portable device that houses effects delivery system 210. When playing musical instrument 201, an analog signal 221 may be sent to effects delivery system 210 and ultimately to sound reproduction system 230, which may include an amplifier, preamplifier, a speaker and other audio components. Analog to digital converter 211 of the effects delivery system 210 converts the analog system received from musical instrument 201 via connection 221. It would be understood however, that musical instrument 201 may also provide a digital signal, which in case analog digital converter 211 would be unnecessary.

When trigger detection 212 illustrated in FIG. 35 detects that a trigger has been received from musical instrument 201, for example, when the musician has played a note that has been programmed as a trigger or has touched a portion of the musical instrument or the like, trigger detection 212 would determine the type of trigger, for example, start playback of sound effect, stop playback, loop sound effects or the like, by reference to trigger definitions 213, which can be any type of memory or storage device. Trigger definitions 213 may be housed in effects delivery system 210 or may be provided in a different module or physical device, or may be provided remote from the effects delivery system 210 and connected via a network. In addition, trigger detection 212 refers to effects memory 214 to determine the type of effect that now needs to be provided and relays instruction to effects processor 216 which produces the effect determined by trigger detection 212. Effects processor 216 then generates a signal representing the effect and digital to analog converter 217 converts this signal to an analog signal, which is transmitted via connection 222 to sound reproduction system 230. Connection 222 may be a wired or a wireless connection.

In addition, if a second trigger is received effects processor 216 can overlay more than one effect on top of one another, or can change the sound of the musical instrument to one produced, as described above. Thus, effects processor 216 can generate and instruct more than one sound effect produced at the same time and can generate and instruct a change or modification to the sound produced by musical instrument 201 and can do these things simultaneously or overlaid on top of each other, and then transmit a signal accordingly to sound reproduction system 230 via digital to analog converter 217 and connection 222. A sound reproduction system 230 that can receive a digital signal can also work effects delivery system 210, and in such a case digital to analog converter 217 would be unnecessary because effects processor 216 would transmit a digital signal over connection 222. In addition, effects delivery system 210 can also be used to generate a digital effects package and to transmit the digital effects package to be uploaded to sound effects sharing system 90 illustrated in FIG. 33 to be stored and shared with other users. However, it will be understood that other implementations and versions of an effects delivery system are also contemplated.

Such triggers can also include a kill switch to stop a current sound effect being played, after the sound clip has been activated by a trigger. The kill switch can be positioned in places analogous to the trigger, such as on a virtual or real fretboard or the like. A button may also be provided for looping, cancelling looping, speed up, slow down of sound clips produced when triggered, and a button can also be provided to enable and disable triggers on the fretboard or elsewhere. Other types of triggers that can be associated with the digital effects package include: a recording trigger, that when activated, records a performance or the output of the musical instrument; recording stop trigger, that when activated, stops recording of the performance or of the output of the musical instrument; a looping trigger, that when activated, loops the sound clip or video clip being performed or played; and a visual effects trigger that when activated, launches performance or playback of a video clip, visual effect, special effect, pyrotechnic display, controls house lights or light beams, controls curtains, or accomplishes a combination of the foregoing. Combination triggers, are also contemplated, for example, a single trigger to trigger a sound clip of visual effect and to kill it in progress, a recording start and recording stop trigger, a looking start and a looping stop trigger, a sound clip and visual effects trigger, and the like.

In addition, triggers as well as kill switch triggers can also be provided for video clips, footage, background visuals, or the like that is played back such as on a display or a projection or the like, for controlling smoke machines or other special effects devices, for opening and/or closing curtains, and for controlling lighting or light beams. Thus, such video and lighting controls can also be associated with and stored on the same digital effects package as the sound effects and triggers, or on a different digital effects package.

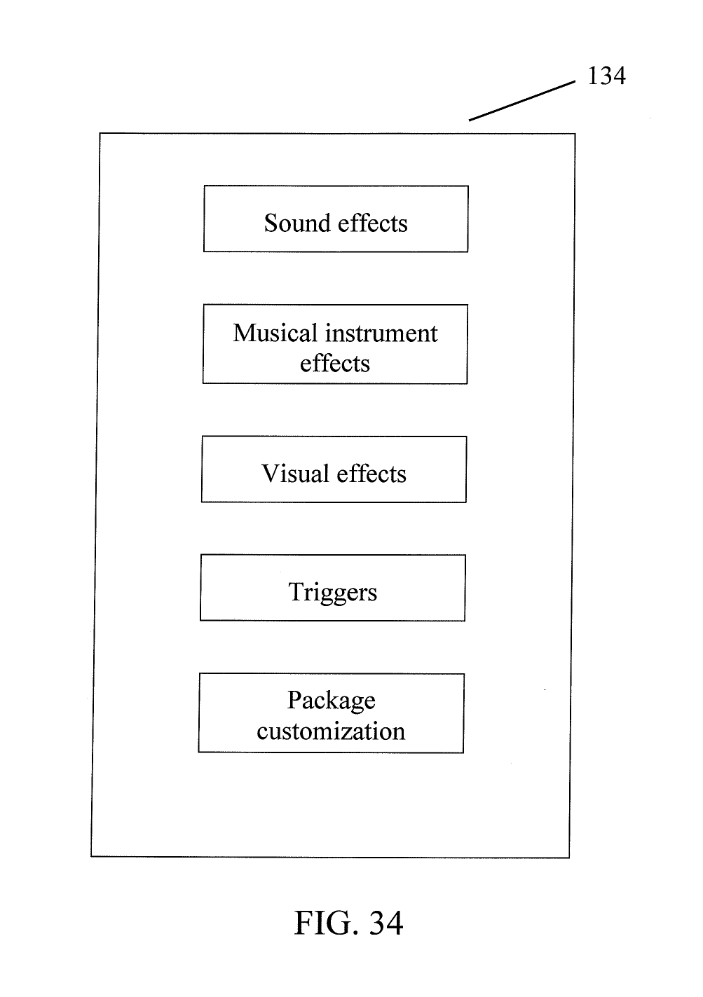

FIG. 34 illustrates a digital effects package, which could include the sound effects that are created and stored by a user as part of the digital effects package. Such a package can be downloaded by a user, including a user different from the user who created the digital effects package, to a local computer, electric pedal, handheld device, smartphone or other portable device, or to a musical instrument properly equipped, for playback, for example, during a performance when the user activates a trigger.

As discussed, musical instrument effects can include changes by a user to the sound produced by a musical instrument to customize the sound of the instrument. Such effects can also be included as part of a digital effects package.

In addition, the digital effects package may also include visual effects, such as video clips, film footage, special effects, pyrotechnics, the activation or deactivation of lights, such as house lights, stage lights, light beams or the like, the providing of visuals or visual displays, smoke effects, the opening or closing of curtains or the like. A visual effects generator may be provided as part of the sound effect sharing system and function in a manner analogous to sound effect generator 91 for creating such visual effects, for associated them with respective triggers, for including them with the digital effects package for the user, and for storing them.

Triggers may also be associated with the digital effects package, and these triggers can include triggers to activate sound effects, musical instrument effects and/or visual effects, as well as triggers to stop or kill the sound effects, the musical instrument effects and/or visual effects, triggers to loop sound effects, musical instrument effects or visual effects, triggers to record and to stop recording of pieces being played and the like. Triggers can also control the rate of playback of sound effects, musical instrument effects or visual effects. In addition, sound effects, musical instrument effects and visual effects can be combined together in various permutations and combinations according to the customization of the user. The same trigger can be associated with more than one action, for example, the first time a rigger is pressed playback can be started, the second time the trigger is pressed, playback can be stopped, the third time it is pressed, recording of the performance can be started, and the like. Alternatively, pressing the trigger once can mean a first action, pressing it twice quickly in succession or pressing it for a longer duration can mean a second action, and the like.

Further, digital effects package 134 can also include digital effects package customization, including the design or look for the package, for example, the package can look like a virtual e-pedal with which musicians are familiar, and other graphical customization of the virtual effects package, including covers and colors can also be made to the “look” of the digital effects package. In addition, digital effects package customization can include the musicians preferences for playback of effects and triggers including the order of effects and the switching of triggers for various effects, the user's history with respect to the digital effects package, such as performances during which the digital effects package was used, the date of creation or the most recent update of the sound clip or of the digital effects package.

In addition, the customization information for the digital effects package may include information used to encrypt or to decrypt the digital effects package so as to protect the digital effects package from tampering or unwanted distribution. Thus, the user can set the degree to which the user will allow other users to view how one or more sound clips of the digital effects package was created, how one or more musical instrument effects was created, how one or more visual effects was created, how triggers were created or their locations, or the like.

Also contemplated is a machine learning feature for detecting patterns in user performance that the user may use for correcting mistakes or for implementing novel effects. For example, the machine learning feature can be activated to remember musical patterns, such as songs or riffs and combinations of pedals, and to correct automatically in real time if the musician plays an incorrect note or presses an incorrect pedal or key.

When preparing to create a sound effect, the user may be presented with a variety of “standard” effects to choose as a starting place, or the user may choose a completely blank project to start from scratch. Example of pre-created basic effects include “blues driver,” “flanger,” “chorus,” “delay,” or other known and preferably non-copyright protected effects. Moreover, the user may “stack” a plurality of effects over each other, for example, to create very unique and original sound effects. The user may have complete autonomy over the sound, as well as have access to virtually every aspect of a particular sound effect. For example, the user may manipulate various features, such as volume, reverb, and more complex effects such as stage, delay timing, or the like. The possibilities are almost endless, especially when considering all the different sounds that can be created for recording programs. In order to have a “hands on” feel, the user will have his or her instrument plugged into the computer or portable device that is electronically connected to the sound effect sharing system to interact with the digital effects package, and will be able to sample their effects in real time. Before a performance, the digital effects package can be downloaded to local computer, handheld device, smartphone or other portable device, or to an external drive, disk or peripheral device thereof, and the musical instrument can be plugged into the computer or other portable device via a USB drive or the like, or can be connected to it electronically. Alternatively or in addition, the digital effects package can be downloaded to a properly equipped smart musical instrument or a peripheral thereof.

While described as a digital effects package, that is activated using sound effect sharing system 90, according to a further embodiment, an actual physical pedal may also be created and designed.

When the user opens the program, a screen appears that allows the user to design a “digital” picture of how the user wants the digital effects package to look like. Design features and options are managed by E-pedal designer 95 shown in FIG. 33. As illustrated in the drawing figures, the user may select from a variety of different pedal shapes and enhance them, such as by changing colors. Alternatively, the user may upload a photograph that will be on the representation of the digital effects package. This same color/image appears when the effect is posted online, provided the user decides to utilize this feature.

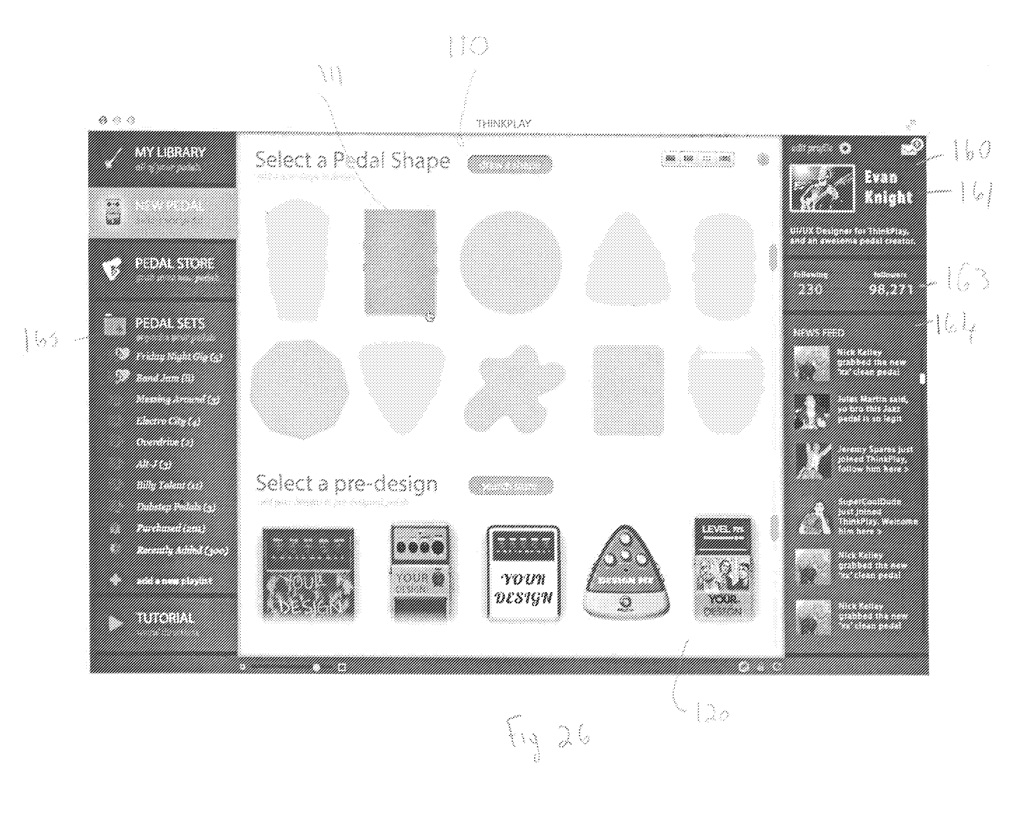

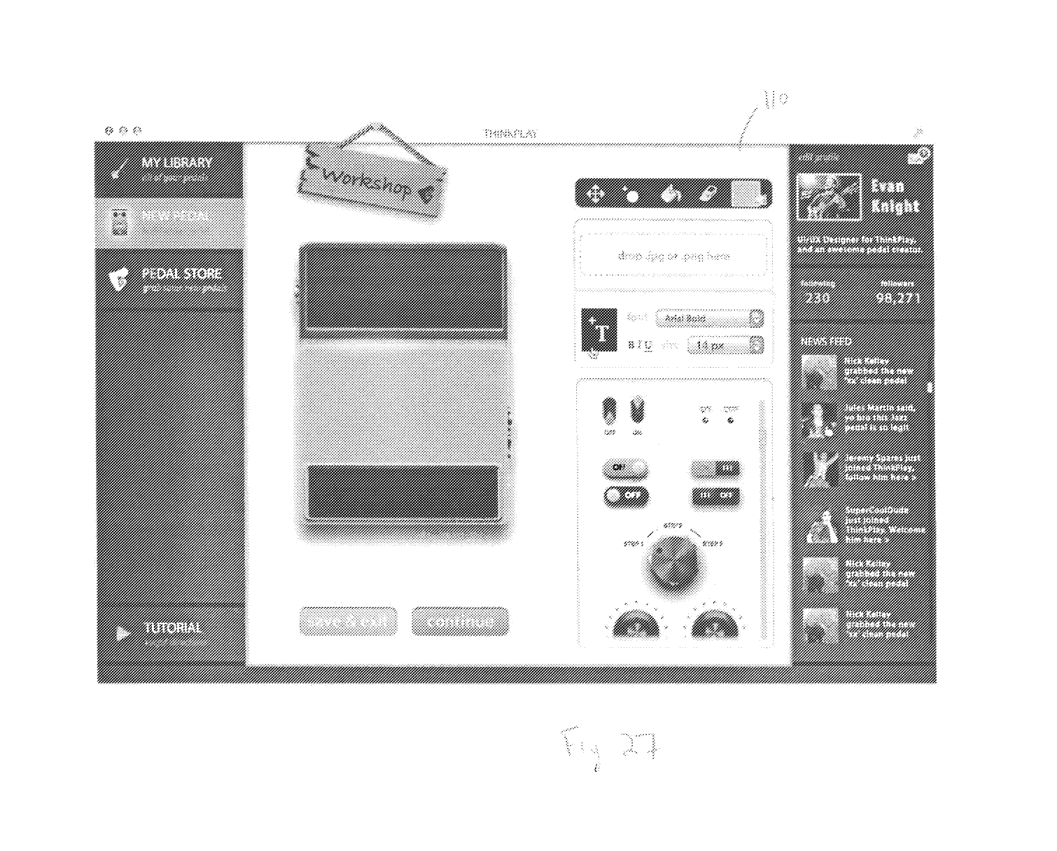

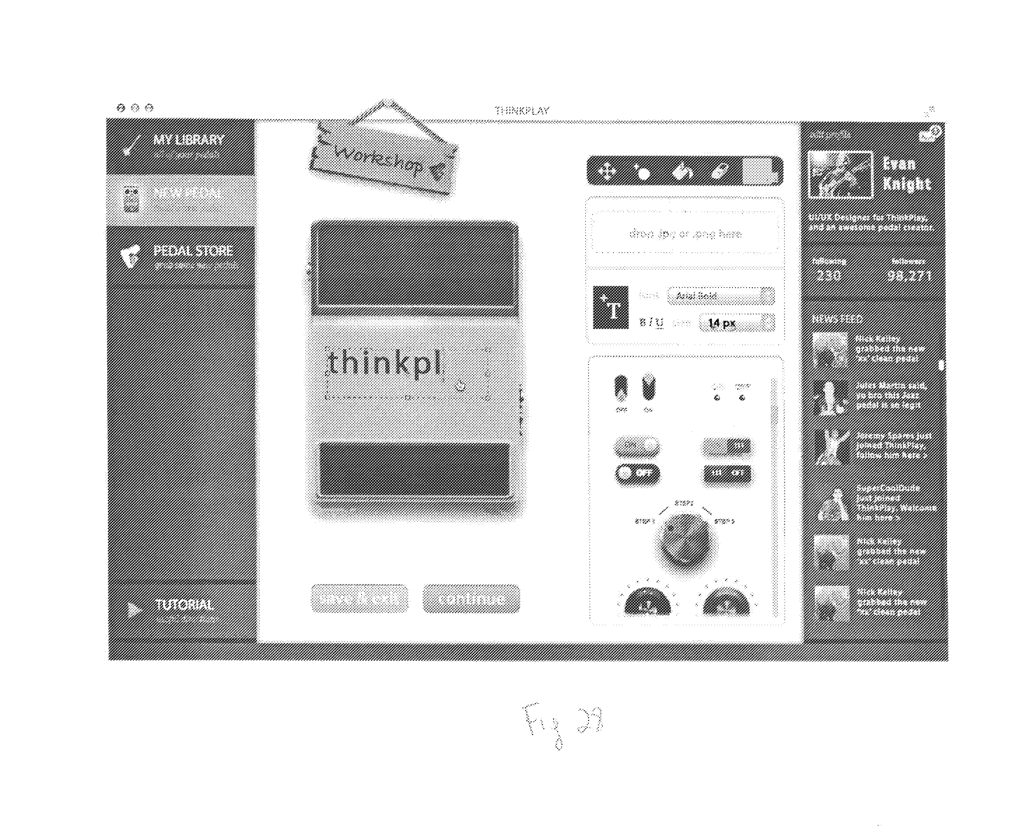

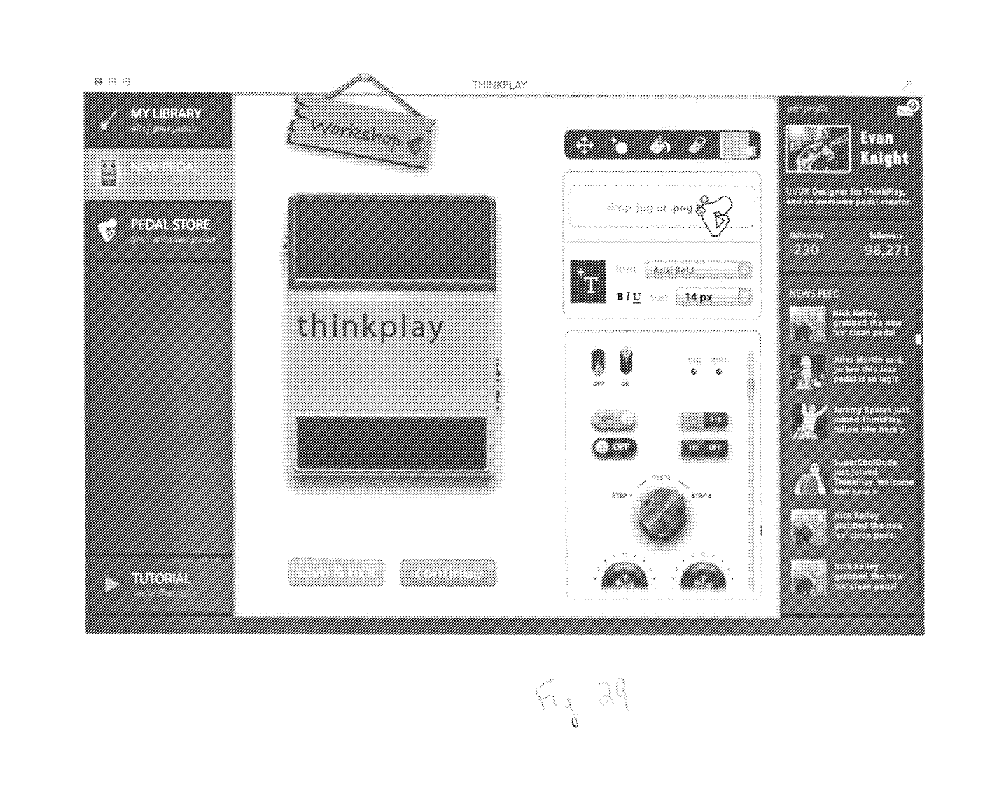

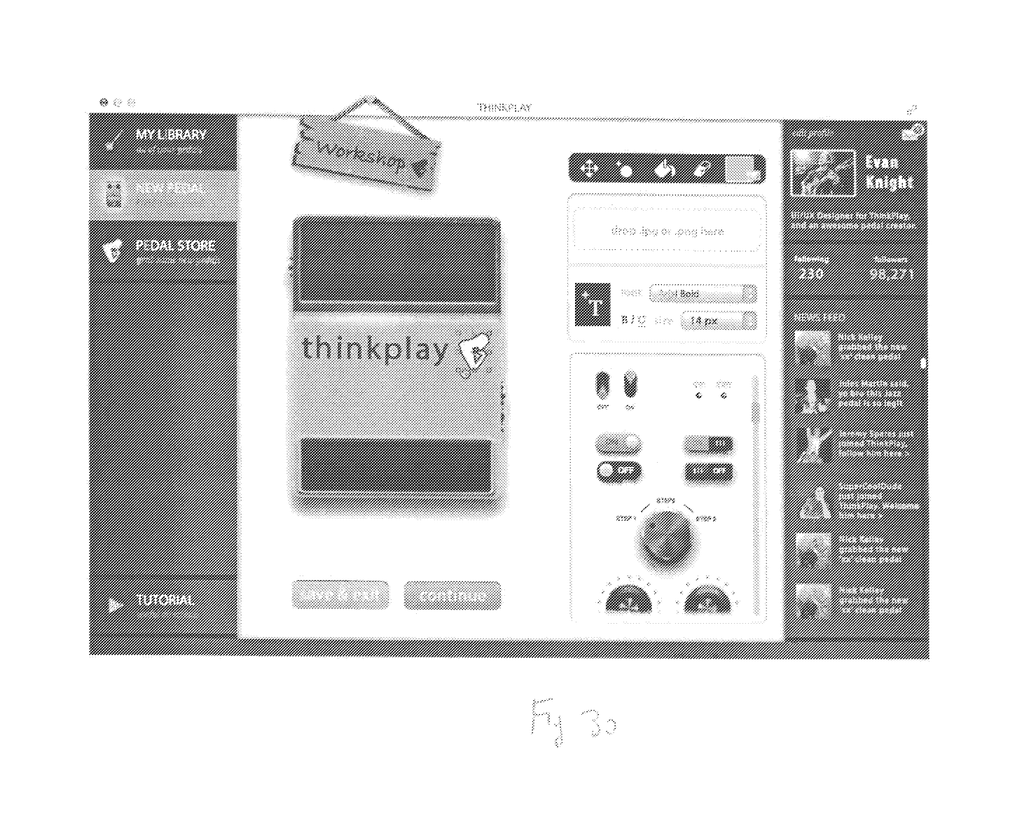

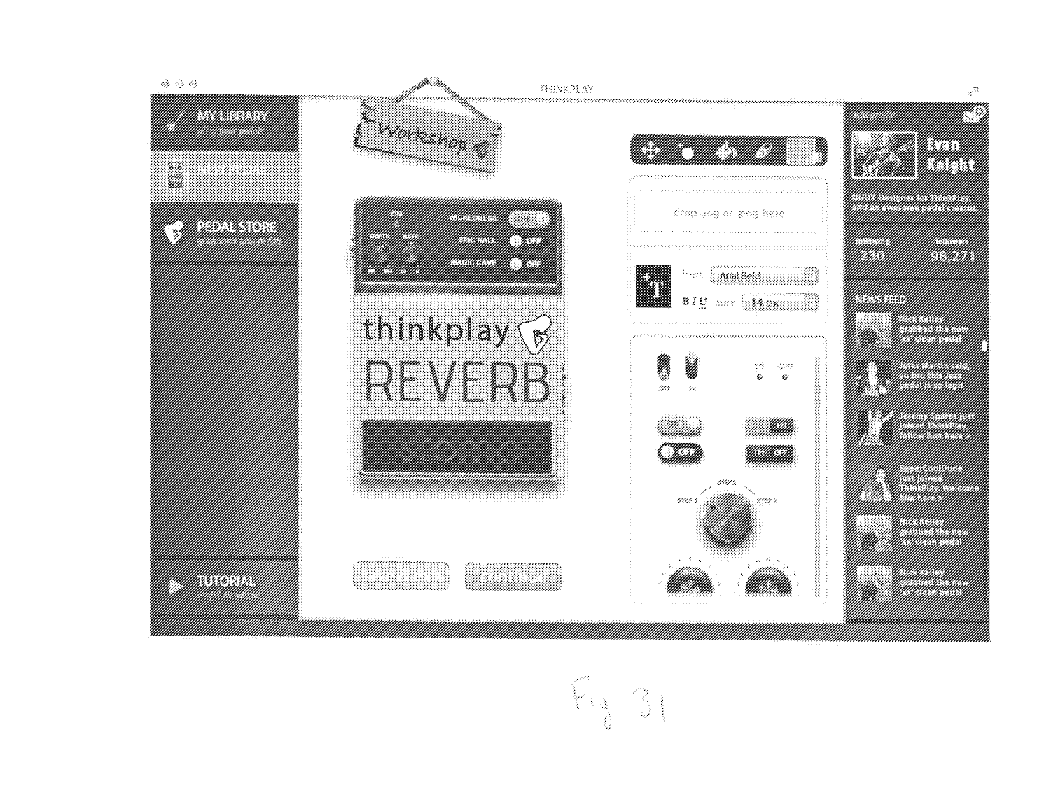

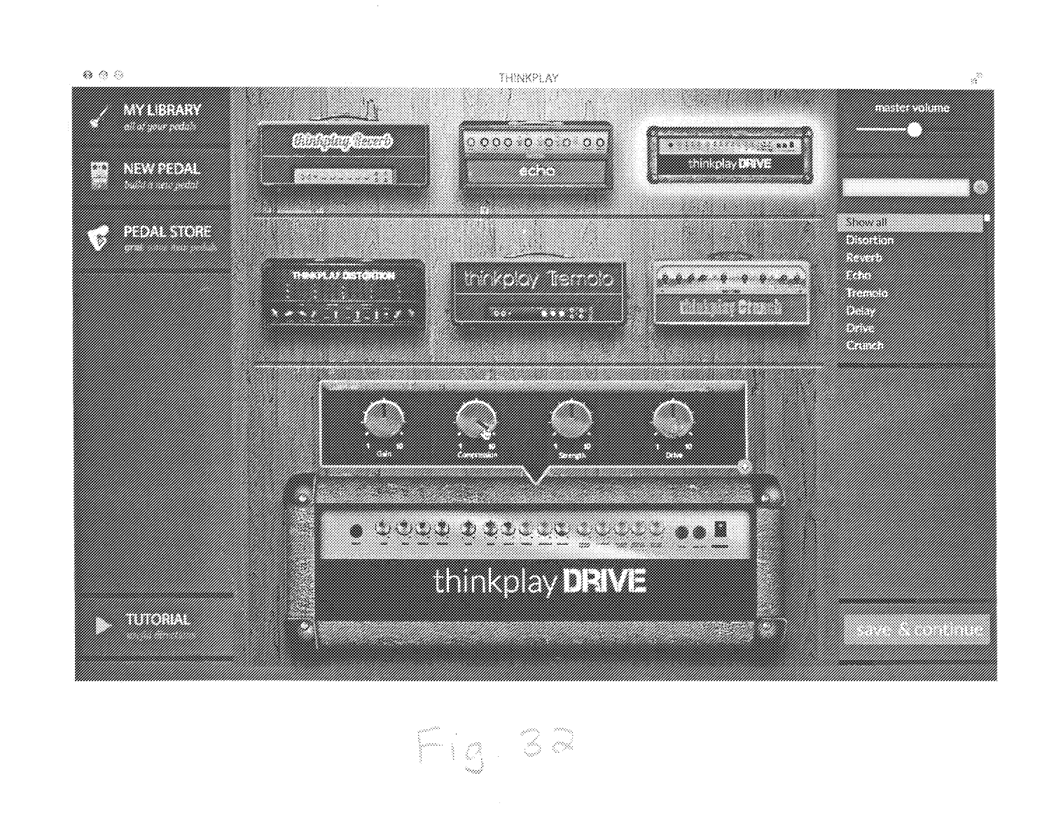

As illustrated in FIG. 26, the user may design the visual representation of the digital effects package in the shape he wants for a particular combination of sound effects or musical performances. FIG. 26 illustrates pedal shape designer 110 to allow the user to draw a shape, for example, a shape 111, that will represent his or her digital effects package. In the alternative, the user may simply select a pre-designed digital effects package for the combination of sound effects that he has saved. FIGS. 27-30 illustrate that the musician may wish to further customize his digital effects package in accordance with his vision for the combination of sound effects he wishes to associate with it. Thus, digital effects package design panel 110 allows user to select a font and a font size and to add various features to the e-pedal. The user can also upload images or drawings or photographs or the like to create the digital effects package design that will be saved for the digital effects package. Pre-designed bar 120 shows digital effects package representations that have been pre-designed and may be purchased by the user.

Once created, the digital effects package may be saved and downloaded, sold or purchased. For example, the user may wish to create the e-pedal and download it to effects delivery system shown in FIG. 35 on his own computer, handheld device, smartphone, or other portable device, or he may wish to download it to an electronic instrument such as a keyboard or properly equipped guitar, then when the digital effects package is activated, such as before or during a performance, pressing the triggers or otherwise activating buttons, knobs, strings, joysticks, soft buttons or other triggers will then trigger the playback of the earlier-stored sound effect, for example DubStepSound3.mp3. User manager 96 illustrated in FIG. 33 can keep track of a user's digital effects, the user's account, the user's past customers, and the like.

Typically however, the user may wish to store a number of sound effects and associate them with a digital effects package, for example, all the sound effects necessary for a song or a musical performance or those sound effects associated with a musical genre, artist, style, mood or the like may be associated with one digital effects package. For example, trigger 73 may be associated with the sound effect DubStepSound3.mp3, while another trigger may be associated with a pre-recorded human chorus, drum roll, electronic organ, piano, wind instrument piece or the like, so that activation of each trigger associated with the digital effects package will then play back their respective sound effect. According to an aspect of the disclosure, second user who downloads, purchases or with whom the user who created the digital effects package otherwise shares the digital effects package, may further change, customize, delete or add to the digital effects package or sound effects, triggers or other information thereon, depending on which content, triggers, pedal design, or the like the user who created the digital effects package has allowed to be manipulated by others. According to a further aspect of the disclosure, the digital effects package may be digitally “locked” after being shared, or at least changes by users other than the user who created it may be prevented, if the user who created it has specified this option.

Also contemplated, is a musical instrument sound modification system that allows the musical instrument sound to be modified, such as using the tremolo, equalizer, and/or wah-wah distortion, flanger, chorus, reverb, overdrive, delay, echo, loop, phase shifter, phaser, compressor, sustainer, volume, feedback, noise, gain, treble, bass, amp simulations, clean, or the like functions. Musical instrument sound controller of sound effect sharing system 90 illustrated in FIG. 90 can enable graphical user interface to provide options to the user and to receive and store selections and sound options and modes made, and then to associate with a trigger and the digital effects package.

These sound modifications can also be used to create the sound effects. Such effects can also be stacked on top of each other and such effects can also be implemented in sequence. In this way, when the digital effects package is activated, a musical instrument connected electronically to a computer or device that has saved the digital effects package will modify the sound produced by the musical instrument according to the previously-created modification. One or more such musical instrument modification can be stored and associated with the digital effects package using the sound effect sharing system 90 shown in FIG. 33, so that the user can create a library of such sound effects and triggers, as well as musical instrument sound modification modalities and associate them with a particular digital effects package that the user needs for a particular performance. In addition, a number of such digital effects packages can be created by the user and saved on the sound effect sharing system 90 or downloaded, shared, sold or purchased from other users using the sound effect sharing system 90.

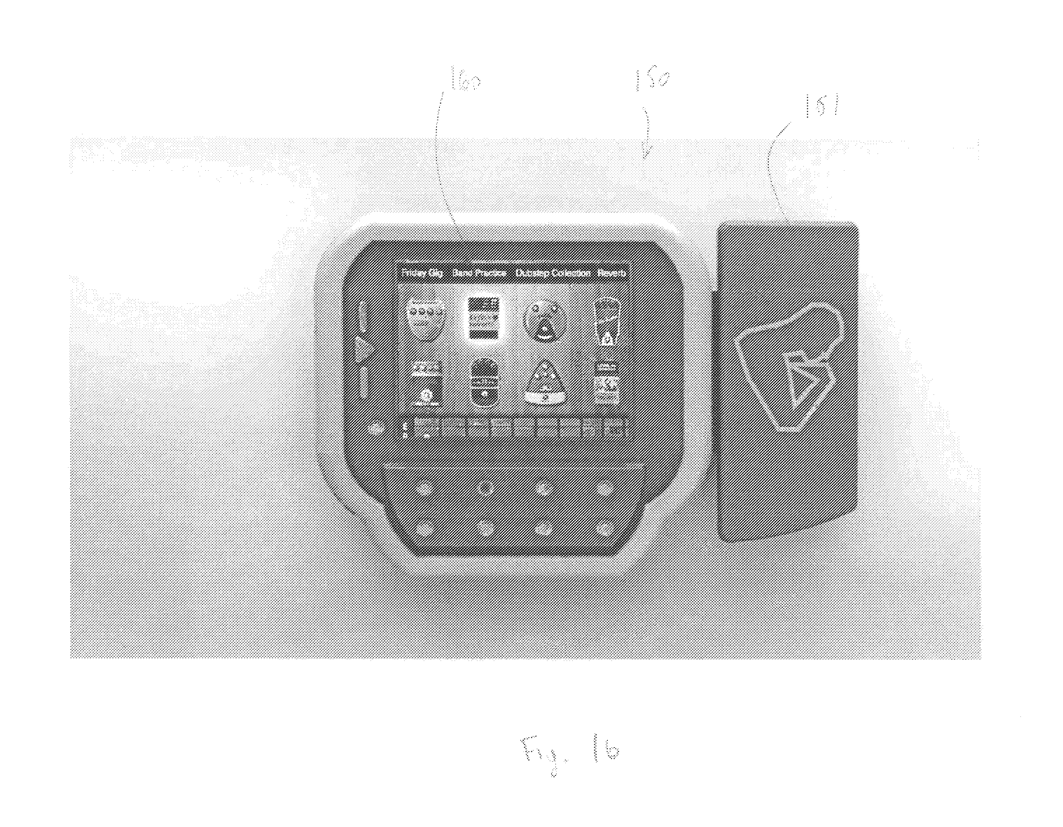

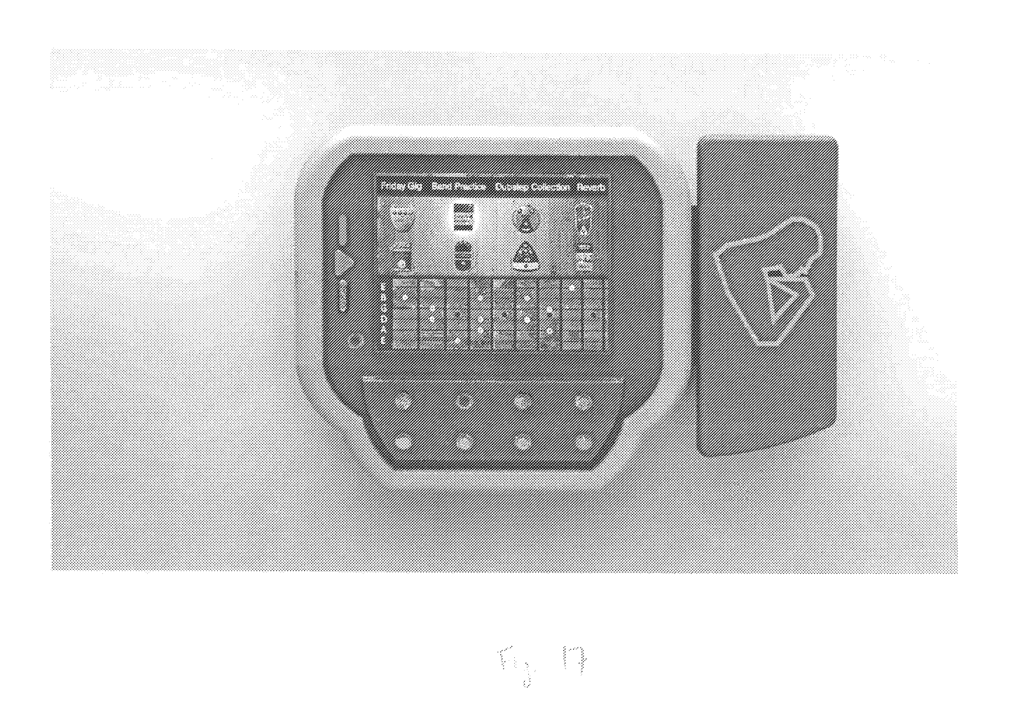

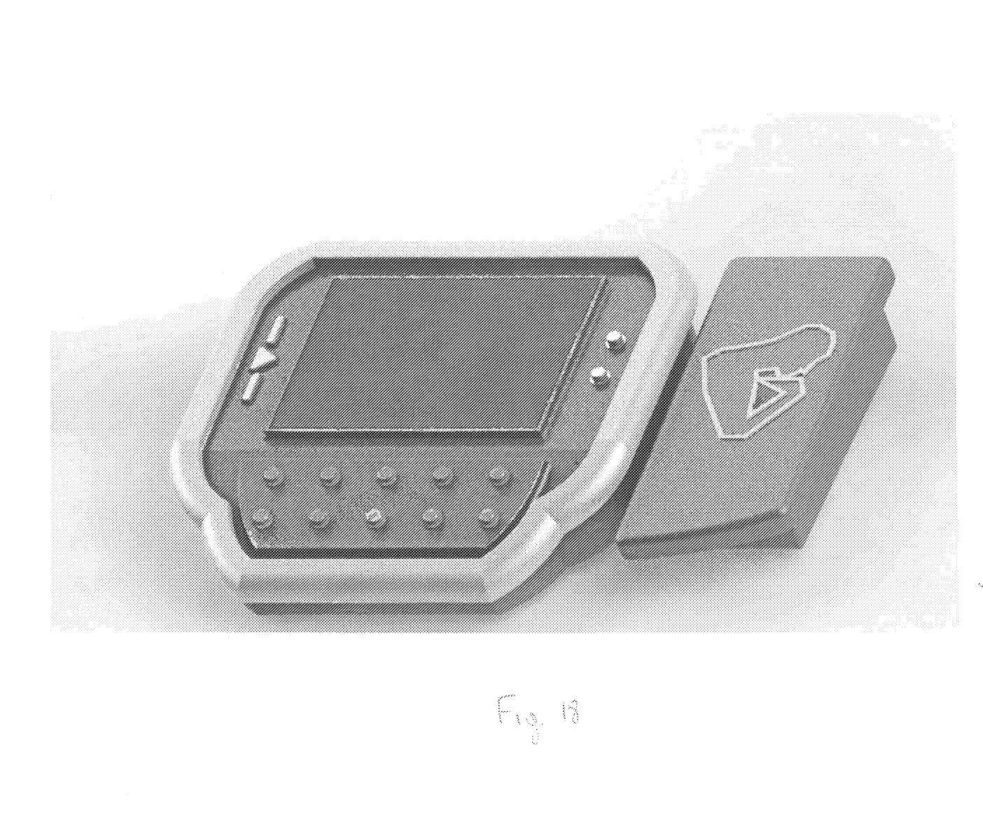

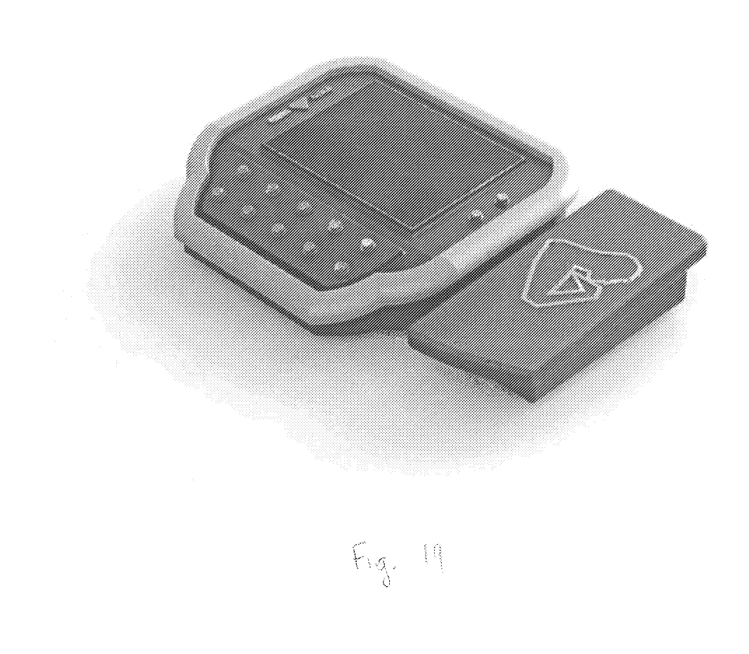

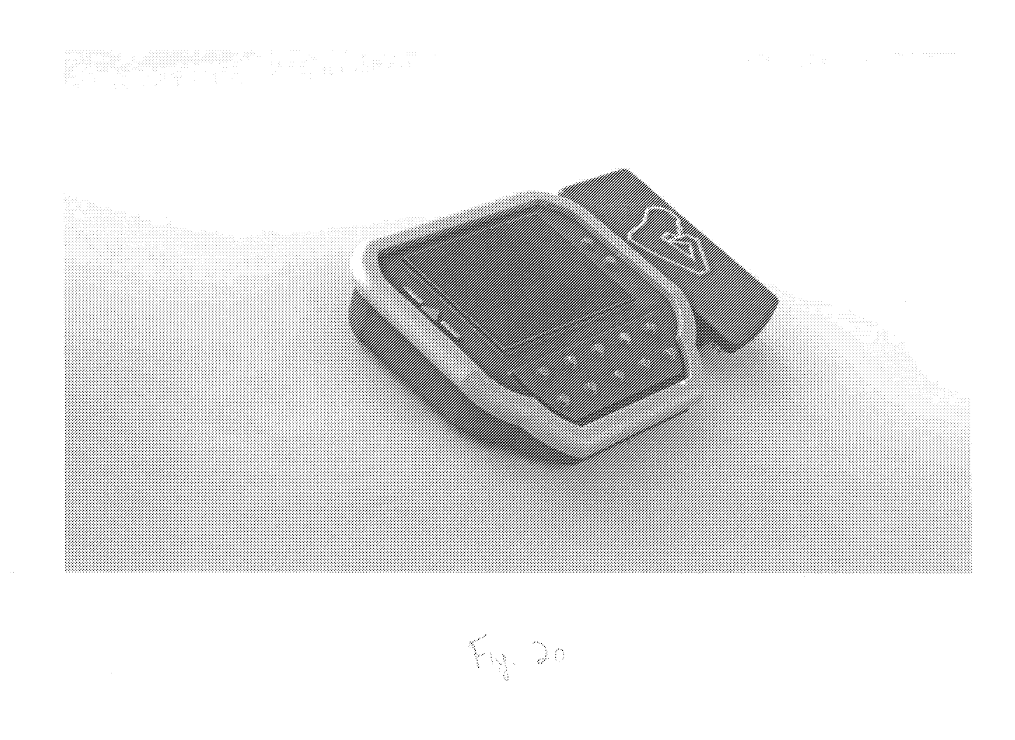

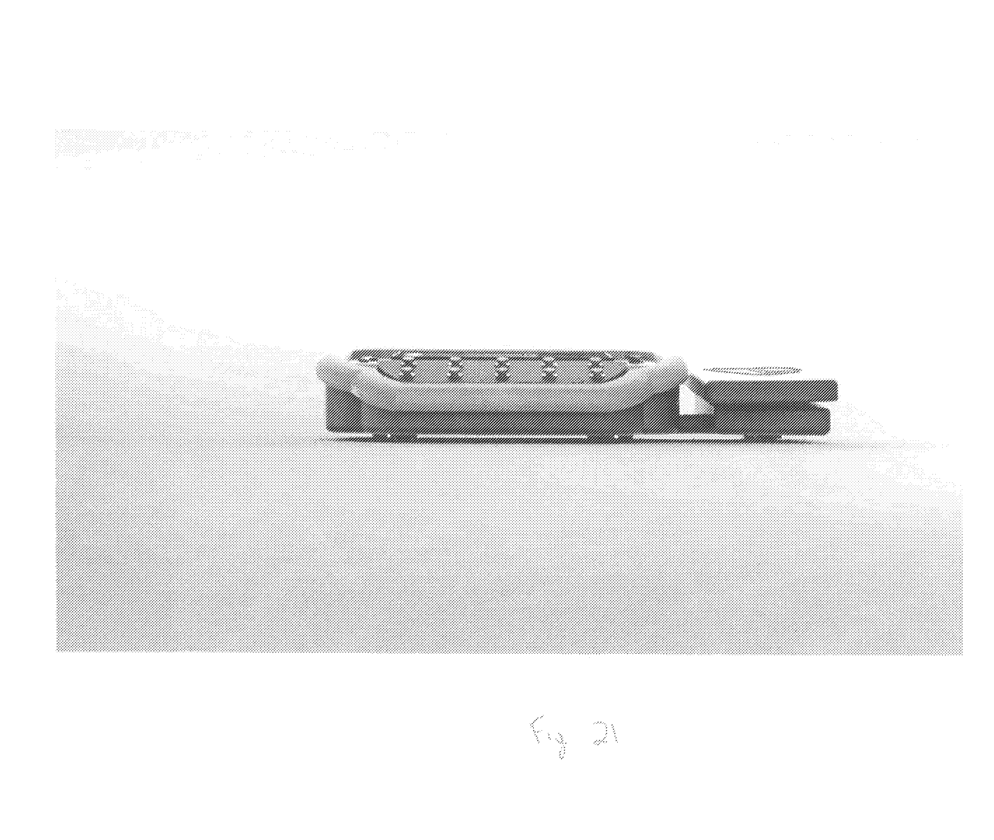

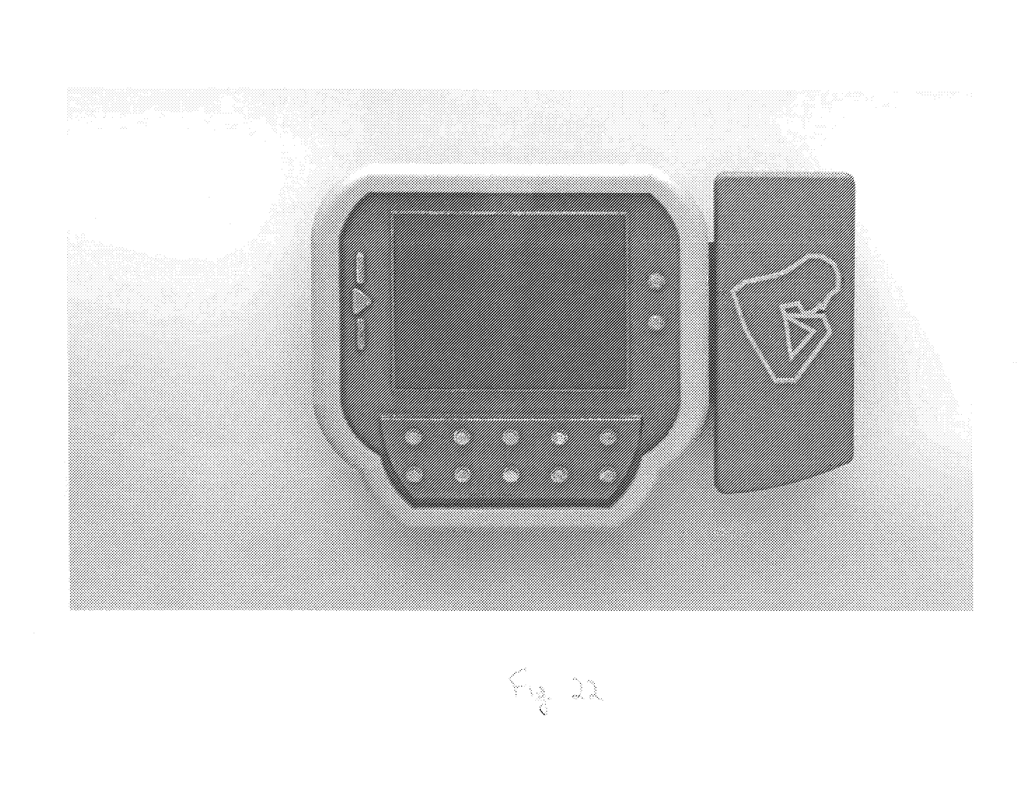

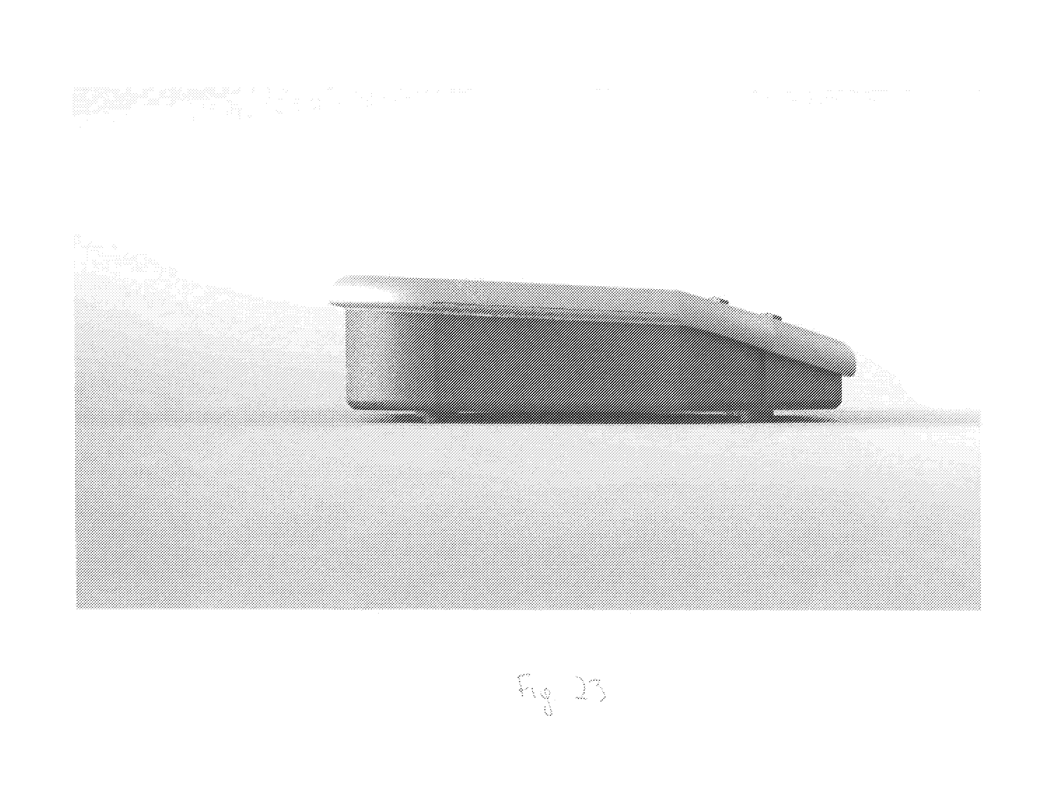

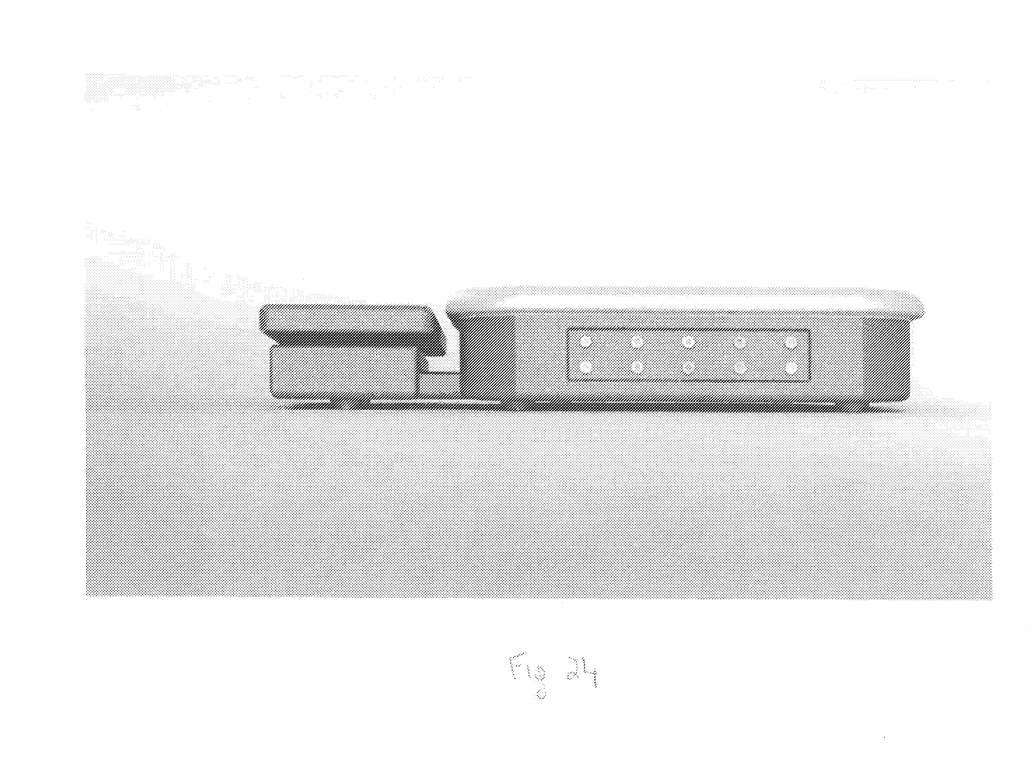

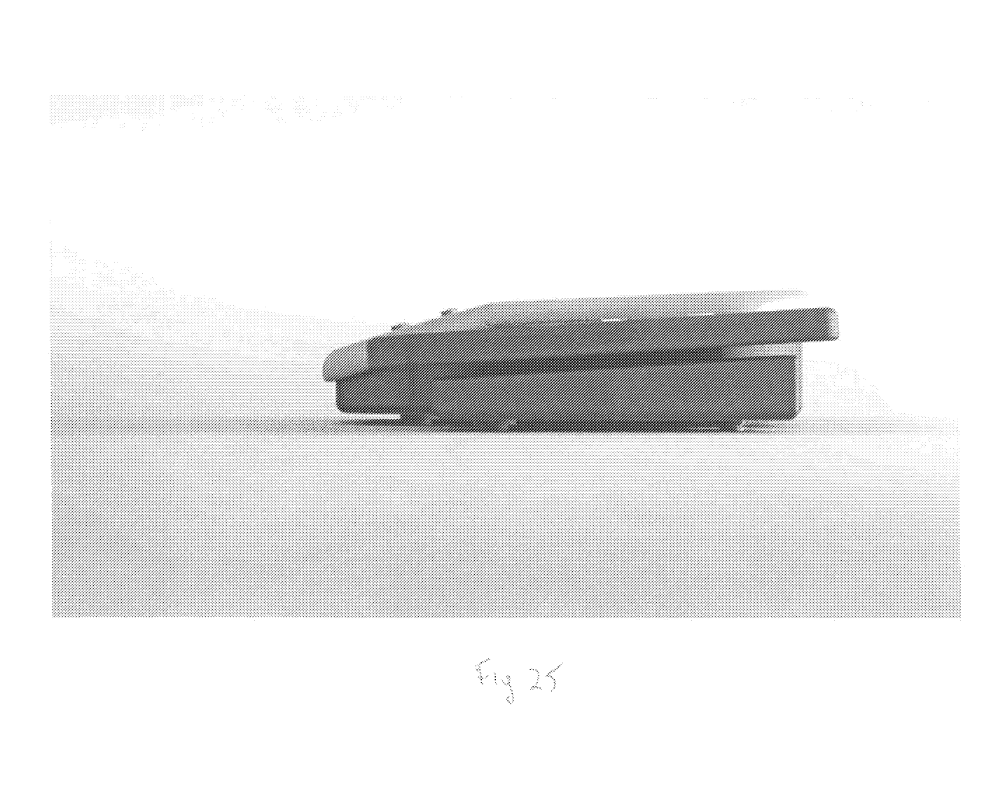

FIGS. 16-25 illustrate a physical electronic pedal to which the user can store a number of digital effects packages using the sound effect sharing system 90. Such a physical electronic pedal can be sold by the platform or separately. The physical electronic pedal 150 includes an electronic display, such as an LED, LCD, OLED display or the like which shows various digital effects packages created and stored there by the user. The physical e-pedal may be designed by the user and then purchased using the sound effect sharing system 90. Then, the user may connect the physical electronic pedal using a computer, handheld device, smartphone or other portable device to a network, such as the internet, or may connect the physical electronic pedal directly to the network to connect up with the sound effect sharing system 90 to download the digital effects packages shown on display screen 160 of physical electronic pedal 150.

Activation bar 151 of physical e-pedals is also illustrated in FIG. 16, which when activated by the user, for example, by stepping on bar 151 or by pressing the same, will then activate the digital effects package selected. In addition, bar 151 may be used to trigger a sound effect associated with a digital effects package that has been activated. In addition, bar 151 may be used to enter a musical instrument sound medication modality previously stored by the system for the digital effects package.

User bar 160 illustrated in FIG. 26 shows that user Evan Knight has logged on and is using the system 90, shows the number of followers this user has and the number of users he is following. Following and followers bar 163 shows a number of users that this user is following, and the number of users that follow him. By following users with whom the user shares musical tastes or musical interest, or are users who are teachers, students, bandmates, fans, customers or the like of the user, the sharing of digital effects packages, and combinations of sound clips as well as the sharing of musical instrument modalities and videos, is facilitated. Users can then sell and purchase digital effects packages that they have designed.

Also shown in user panel 160 in FIG. 26 is a newsfeed panel 164 that provides news tailored to the musical tastes and interests, e-pedal selections and purchases and sales and followers of user 161. Pedal set panel 165 on the left side of FIG. 26 illustrates the digital effects packages associated with this user. It will be understood that other social networking features and functions may also be incorporated in the system to allow users to communicate, for example, using messaging, to send files, sound effects or digital effects packages to each other, to comment on each other's digital effects packages, and statuses and the like. Also, a third party payment platform, such as PayPal, or a credit card charging platform may also be connected so that transactions can be facilitated when users buy or sell digital effects packages. The system may keep a percentage or a flat fee for digital effects packages sold to each other by the users. In addition, advertising, including target advertising may also be shown to the users.

In accordance with the present application, an online network is provided that can be relatively simple to use. For example, after a user is satisfied with a custom-built effects pedal, the user uploads the effects onto an online database via the user's respective username. This username may be created when the user first installs the program on his/her computer.

The user has the opportunity to give the new pedal a name (each name should be unique so simple names such as ‘distortion’ will be rejected), and may be able to post them online for free, or for a price of their choice. In an embodiment, profit may be made, for example, by receiving a percentage of all effects and/or sold through the network. Similar to that of ITUNES and YOUTUBE, musicians may create their own businesses by making pedals and effects that other consumers may choose to purchase and play their pedals. A hierarchy of users can be created based on particular users popularity on the site. There will be sections on the site, which may include ‘top free,’ and ‘top effects.’ All users will have access to an online store with potentially millions of unique effects, which they can download. Users have the ability to decide whether or not to allow other users who download an effect and/or pedal to be able to manipulate it further if they choose to, or whether the effect and/or pedal is ‘locked’ and unable to be accessed.

Users may, in accordance with the present application, start their own pedals/effects companies and may further choose to keep their effect formulas a secret. Users will be notified of whether they can alter the effect or not before they choose to download/purchase the effect. Potential buyers may preview a 10-40 second recording of an effect, which is provided when the user posts the effect. As well, each user may be given their own ‘page’, which can be sent to their peers for easy sharing and networking. A rating system is further supported, in which users can choose to ‘rate’ the effects that other users have produced. One of the main ideas behind the site, as well as allowing users to define their own effect prices, is autonomy. If users want to try and profit and start a business from this site, they have complete control over what business decisions they will make in that regard.

Another unique feature in accordance with the present application is a digital guitar function. Every note on a guitar has a unique frequency. These frequencies are picked up and manipulated with an effect before coming out of the amplifier. The digital guitar functionality in accordance with the present application takes this idea to a higher level. A musician has the ability to include small digital sound clips, which may by anything from a voice speaking, to an explosion, to a turntable scratch, and when the musician hits that note, the amplifier will produce that clip. The user may choose to put digital effects on specific notes, or on a specific region of the guitar so that (s)he can play a typical (preferably electric) guitar while now including digital effects. This feature may be advertised as the “main wonder” of this program, and fuses the ideas of what DJs can do on their laptops with what musicians can do with their instruments. This creates a completely unexplored area of playing in which musicians can now begin including more than notes in their sound, and in their guitar solos.

Accordingly, the following lists some of the features disclosed herein: 1) software for creating/building effects; 2) a pedal board that these effects can be uploaded onto (may potentially be outsourced); 3) an online network in which these effects can be traded and/or sold; and 4) the digital guitar.

One or more software applications may be downloaded to a computer or portable device of the user to make possible the interaction with the graphical user interface provided by the sound effect sharing system.

Although the present invention has been described in relation to particular embodiments thereof, many other variations and modifications and other uses will become apparent to those skilled in the art.

1. A method of playing a digital sound clip the method comprising:
creating a digital sound clip;
hitting a note on a guitar; and
producing, by an amplifier, the digital sound clip in response to hitting of the note.

2. The method of claim 1, wherein the digital sound clip is downloaded after the creating of the digital sound clip.

3. The method of claim 2, further comprising manipulating the digital sound clip after the digital sound clip is downloaded, before the note is played on the guitar.

4. A computer-readable medium incorporating instructions configured to enable a user to create and to share a digital effects package, the instructions comprising:
first sound effect interface instructions configured to enable user input, to a computer, of a first sound effect, and to enable user input of a first trigger that, when activated, plays the first sound effect, and to associate the first sound effect and the first trigger with the digital effects package;
second sound effect interface instructions configured to enable user input, to the computer, of a second sound effect, and to enable user input of a second trigger that, when activated, plays a second sound effect, and to associate the second sound effect and the second trigger with the digital effects package; and
digital effects package displaying and storing instructions that, when transmitted automatically by the computer, cause the digital effects package to be displayed and to be stored for later activation of the first and second triggers, and enable sharing of the digital effects package by a first user at a first terminal and a second user at a second terminal, the first and second terminal connected via a network.

5. The computer-readable medium of claim 4, wherein the instructions further comprise:
musical instrument sound modification interface configured to receive, by the computer, a user command to alter a sound produced by a musical instrument and to associate the input instruction with the digital effects package; and
musical instrument sound modification instructions configured to modify the sound of the instrument in accordance with the command when the digital effects package is activated.

6. The computer-readable medium of claim 4, wherein the first trigger is a spot on a guitar fretboard connected to the computer.

7. The computer-readable medium of claim 4, wherein the first trigger is a spot on a stringed musical instrument fingerboard.

8. The computer-readable medium of claim 4, wherein the first trigger is a key or a note on a musical instrument.

9. The computer-readable medium of claim 4, wherein the first trigger is a button on a musical instrument.

10. The computer-readable medium of claim 4, wherein the instructions further comprise:
visual effects interface instructions configured to enable user input, to the computer, of a video clip, a visual effect, special effects, or pyrotechnics effects; and
third trigger selection instructions configured to enable user input of a third trigger that, when activated, commences performance of the video clip, the visual effect, the special effects, or the pyrotechnics effects, and to associate the video clip, the visual effect, the special effects, or the pyrotechnics effects and the third trigger with the digital effects package.

11. The computer-readable medium of claim 4, wherein the instructions further comprise:
recording trigger interface instructions configured to enable user input, to the computer, of a recording trigger that, when activated, commences recording of a performance as a recorded sound effect, and to associate the recording trigger with the digital effects package.

12. The computer-readable medium of claim 11, wherein the recording trigger is a spot on the stringed musical instrument fingerboard.

13. The computer-readable medium of claim 4, wherein the instructions further comprise:
first kill switch interface instructions configured to enable user input, to the computer, of a first kill switch trigger that, when activated, stops playback of the first sound effect, and to associate the first kill switch trigger with the digital effects package.

14. The computer-readable medium of claim 11, wherein the first kill switch trigger is a spot on a stringed musical instrument fingerboard.

15. The computer-readable medium of claim 4, wherein the instructions further comprise:
looping trigger interface instructions configured to enable user input, to the computer, of a looping trigger that, when activated, commences looping of a selected sound effect, and to associate the looping trigger with the digital effects package.

16. The computer-readable medium of claim 15, wherein the looping trigger is a spot on a stringed musical instrument fingerboard.

17. A system comprising the computer-readable medium of claim 4, and a remote module comprising:
remote module instructions configured to be executed by a second computer, the second computer being remote from the computer in communication over a network with the computer, and the remote module instructions configured to provide a graphical user interface to enable user input of the first sound effect and the first trigger.

18. The system of claim 17, wherein the remote module further comprises:
musical instrument interface instructions configured to enable user input of the first sound effect from a musical instrument.

19. The system of claim 17, wherein the remote module further comprises:
trigger receiving instructions configured to enable user input of the first trigger from a musical instrument, and to associate the first trigger with the first sound effect.

20. A method of enabling a user to create and to play a digital effects package, the method comprising:
receiving, by a machine, from a user, user selection of a first sound effect and user selection of a first trigger, that, when activated, plays the first sound effect;
associating the first sound effect and the first trigger with the digital effects package; and
playing the sound effect when the user activates the first trigger, the first trigger being a position on a fingerboard of a stringed musical instrument.

21. The method of claim 20, further comprising:
receiving, by the machine, user selection of a second sound effect and user selection of a second trigger, that, when activated, plays the second sound effect;
associating the second sound effect and the second trigger with the digital effects package; and
playing the sound effect when the user activates the second trigger.

22. An audio modification system comprising processor executable instructions including:
instructions to define a trigger signal based on a user input;
instructions to enable a processor to detect a first trigger signal received from a signal input;
instructions to activate a first sound effect function associated with the first trigger; and
instructions to modify a signal received from the signal input according to the first sound effect function.

23. The system of claim 22, wherein said processor executable instructions further include instructions to enable the processor to detect a second trigger signal received from the signal input and to deactivate the first sound effect function upon detection of the second trigger signal.

24. The system of claim 22, wherein said processor executable instructions further include instructions to enable the processor to detect a third trigger signal received from the signal input, to activate a second sound effect function upon detection of the second trigger signal, and to further modify the modified signal with the second sound effect function.
